(19) United States
(12) Patent Application Publication
(10) Pub. No.: US 2003/0206021 A1
(43) Pub. Date: Nov. 6, 2003

(54) Method and apparatus for measuring and analyzing electrical or electrochemical systems

(76) Inventors: William H. Laletin, Slidell, LA (US); Kurt Salloux, Topanga, CA (US); Logan L. Brashear, Malibu, CA (US)

Correspondence Address: Mark S. Leonardo, Esq., Brown Rudnick Berlack Israels LLP, One Financial Center, Boston, MA, 02111, US

(21) Appl. No.: 10/443,230

(22) Filed: May 21, 2003

Related U.S. Application Data
(63) Continuation-in-part of application No. 09/122,181, filed on Jul. 24, 1998.
(60) Provisional application No. 60/054,466, filed on Jul. 25, 1997.

(51) Int. Cl. G01N 27/416

(52) U.S. Cl. 324/426

(57) ABSTRACT

A method and apparatus for creating a time-varying electrical excitation, delivering it to a system comprising at least one electronic or electrochemical element, and measuring and analyzing a time-varying electrical response developed within the system in response to the excitation. The response signal, and optionally the excitation signal, are sampled in a synchronous manner, and the sampled values are analyzed to determine various characteristics of the system, including State of Charge and State of Health. Additional analysis may be performed to: identify specific system defects; identify and quantify time-dependent processes; and, obtain values for elements of an equivalent electric circuit model. The method and apparatus may serve both as a measurement system as well as a control sub-system, and may be configured to operate in either an open-loop or closed loop manner. Furthermore, the method and/or apparatus may be used in conjunction with a power control system such as an electrical/electrochemical system test device, a battery charger, a battery conditioner, or a battery backup system or uninterruptible power supply. Alternate embodiments of the technique may be achieved by integration directly within a chip or chipset.

### RELATED APPLICATION INFORMATION

This patent application is a continuation-in-part of U.S. Utility patent application Ser. No. 09/122,181, filed in the U.S. patent and Trademark Office on Jul. 24, 1998, which claims priority to U.S. Provisional Application No. 60/054,466, filed in the U.S. patent and Trademark Office on Jul. 25, 1997 and U.S. Utility patent application Ser. No. 09/155,308, filed in the U.S. patent and Trademark Office on Dec. 8, 1998, now U.S. Pat. No. 6,411,098, and PCT/US97/05002, filed in the U.S. patent and Trademark Office on Mar. 27, 1997, which claims priority to U.S. Provisional Application No. 60/014,159, filed in the U.S. patent and Trademark Office on Mar. 27, 1996, the entire contents of which are incorporated herein by reference.

### BACKGROUND OF THE INVENTION

The invention relates to the testing, evaluation and control of systems incorporating electrical and electrochemical elements, each of which elements exhibits the general characteristic of impedance, or conversely, admittance. A Device Under Test (DUT) comprising at least one electronic or electrochemical element is excited with a time-varying electrical signal, and a sampling means, operative synchronously with an excitation means, is employed to acquire the time-varying response of the DUT. A variety of analyses may be performed on the acquired data to determine characteristics of the DUT; additionally, alternate embodiments of the invention may be used to assist and/or control power systems that incorporate electrochemical accumulators.

A wide range of frequency domain and time-domain methods have been proposed as means to investigate the properties of electrical and electrochemical systems. To perform a frequency domain test, a sinusoidal excitation is applied to the DUT and its response is measured and analyzed to extract values related to its impedance (or, conversely, its admittance), which impedance is a vector quantity known to comprise both real and imaginary components each characterized by a phase angle with respect to the vector. When a plurality of tests are performed at different frequencies, a characteristic impedance profile may be developed, from which many important characteristics of the DUT may be inferred. For certain applications, however, only one component of the vector impedance, such as its real part, is sought. This component represents a scalar value, and may be accompanied by its phase angle relative to the actual impedance vector. In other cases only the magnitude (that is, the modulus) of the overall vector impedance is determined.

When testing in the time domain, the excitation employed is generally not sinusoidal, but instead comprises rectilinear, sloped or triangular portions, where a rectilinear waveform exhibits a fast rise-time leading edge, a next portion having a substantially constant amplitude, and a fast rise-time trailing edge. In general, the excitation exhibits at least one distinct discontinuity such as an abrupt amplitude step, or a sudden change of amplitude slope at the junction between two linear portions. Commonly used excitation waveforms include a single step, rectangular pulses, square waves, triangle waves, constant-slope ramps, sawtooth waves, and the like.

Frequency Response Analysis is regularly employed to extract information from frequency domain data. Sometimes referred to as impedance spectroscopy, the technique was developed for investigating the behavior of systems comprising electrical elements and/or energy devices such as electrochemical cells or batteries (cf. MacDonald, “Impedance Spectroscopy”, Wiley 1987). In general, the technique employs a well-defined sinusoidal electric stimulation (sic, an AC voltage or current of known amplitude, frequency, and phase) that is applied to a DUT, whereupon the resultant in-phase and quadrature components of the DUT's response are determined and used to calculate the real and imaginary components, respectively, of the device's impedance by using Ohm's law (E=I*R or R=E/I). The corresponding admittance values may be directly determined as well. By taking a series of measurements over a range of frequencies, the characteristic response profile of the DUT is obtained. From the real and imaginary impedance (or admittance) values, other quantities, such as, for example, phase angle and modulus, may be derived.

Quantitative analysis of the frequency domain data is regularly achieved by using nonlinear least squares fitting techniques, whereby values may be calculated for the elements of an a priori equivalent circuit model or circuit analog. When the DUT is an electrochemical system, a well-chosen model will contain individual elements corresponding to the underlying chemical and kinetic processes occurring in the system.

Frequency response analysis is very robust, but usually requires the performance of multiple, individual tests at a variety of discrete frequencies to obtain a complete frequency response profile. The duration of the test process may be considerable, especially if high resolution, low frequency response information is required. In addition, if the time domain response of the DUT is desired, it must be obtained by simulating the performance of the postulated equivalent circuit model that has been populated with elements exhibiting the values calculated from the frequency domain data. In this case, the accuracy of the simulated response is strongly dependent on the topology of the a priori model and the accuracy of the raw data. To reduce testing time, specialized excitations may be employed such as a multi-frequency signal or a noise signal (which implicitly contains many frequency components); the subsequent analysis must be capable of deconvolving the contributions of each excitation frequency component from the aggregate response.

To overcome the limitations of frequency-based techniques, a number of direct time domain measurement techniques have been developed. Commonly used techniques include voltammetry, polarography, chronoamperometry and chronopotentiometry, among others. The distinguishing characteristic of these time domain methods is that the sinusoidal excitation is replaced with an excitation comprising linear portions separated by abrupt transitions. It is often convenient to represent such an excitation as a sequential set of one or more distinct waveforms each comprising two distinct portions, or part-cycles, that are separated by abrupt transitions. Within each part-cycle, the amplitude takes the form of a linear segment having either a constant value or a linearly ramping value (i.e., having a constant slope). When only a single abrupt transition occurs during the entire duration of an excitation event, the excitation will comprise either a single pulse or a single ramp.

Typical time-domain excitation waveforms that may be employed include, for example: triangle or square waves; rectangular pulses, sawtooth waves, etc., any of which could be followed by, or interspersed with, zero-excitation intervals. More complex excitation protocols may be used as well, including composite signals such as a stepped potential staircase with (optionally) a smaller periodic signal superimposed on each step. For certain applications, sine wave excitation may be employed.

Note that the characteristics of many of the time-domain excitation signals described above closely resemble those found in pulse-type and so-called “rapid” battery chargers and battery conditioners. By providing both a suitable means of controlling excitation waveform characteristics (i.e., the period, duty-cycle and amplitude of each cycle) along with suitable synchronous sampling means, the inventive method may be constituted to provide both tester functionality and charger (or discharger) functionality.

Because primary (single-use) cells are not intended to be recharged, a number of traditional time-domain measurement methods, including chronopotentiometry/chronoamperometry (both conventional and cyclic), have been modified for use with primary cells. Here, the excitation usually appears as a discharge-type protocol, comprising combinations of a ‘constant value step’ or ‘pulse followed by relaxation interval’. One commercially available LiSO₂ battery tester employs such a ‘pulse discharge/relaxation’ method, where a relatively high current discharge event (60 seconds, at about a C/4, where C represent the nominal amp-hour capacity of the cell) is followed by a ‘rest’ period wherein the battery is placed on open-circuit: the profile of the battery's recovery voltage is used to diagnose the state of charge. When severely depleted batteries are tested with this test device, the high current levels employed can occasionally lead to ‘venting’ of SO₂ gas, with the attendant possibility of cell rupture. As a consequence of this possibility, multiple sequential tests of the same cell/battery are strongly discouraged when using this test device. In contrast, the present method utilizes a time-varying excitation whose effects can be accurately monitored throughout the test, so that adjustments may be immediately made to the excitation to accommodate the sensed condition of the cell/battery. If any fault condition is detected in the device under test, the excitation may be attenuated or discontinued to avoid problems.

In light of the hazards posed by an incorrect application of time-domain test methods to sensitive chemistries such as LiSO₂, attempts have been made to use frequency response analysis (that is, electrochemical impedance spectroscopy) to evaluate these cells. However, the impedance profile of this cell type remains virtually flat across a wide range of test frequencies until nearly the end of its useful service life. As noted above, to obtain a reasonable impedance/frequency profile using FRA techniques, sophisticated measuring equipment must be used to provide multiple (sequential) tests at a plurality of frequencies, resulting in severely protracted test times.

Accordingly, a need exists for a method and apparatus suited for performing accurate time-domain measurements and analyses to allow characterization of electrical and electrochemical systems, which method and apparatus may be incorporated to provide measurement and control functions within devices related to battery charging, battery conditioning, battery monitoring, and the control of power backup systems employing electrochemical energy sources.

### SUMMARY OF THE INVENTION

The invention provides a method and apparatus for measuring and analyzing the time-varying electric response produced in an electrical or electrochemical element or cell when excited by a time-varying electrical signal; when the excitation takes the form of a current signal, the attendant response is conventionally referred to as the time-dependent polarization voltage. The response is detected and converted into digital format by a sampling means, operating according to a sampling schedule that is synchronized with the excitation means; the excitation signal itself may also be sampled in a synchronous manner. The method can be generally used to evaluate the time domain response of systems, which exhibit the property of electrical impedance (or conversely, admittance). The inventive method may be embodied in an open-loop form wherein the results of measurements and analysis are provided, or in a closed-loop form wherein said results are used to provide feedback, to modulate the behavior of a system or device.

An electrical element here is distinguished from an electrochemical cell in that voltage potential changes occurring in the electric cell are indicative primarily of charge storage and energy loss effects due to dielectric behavior (e.g., lossy capacitor), whereas potential changes observed in an electrochemical cell reflect additional processes including physical changes (mass transport, diffusion) as well as various Faradaic and non-Faradaic electrochemical reactions.

The invention allows rapid and accurate acquisition of information relevant to the state of charge and qualitative information about an electrochemical energy storage device, commonly referred to as a cell or battery. The technique permits the implementation of a precision test instrument that produces precise galvanic (that is, current-mode) excitation signals to create time varying polarization response voltages within an electrochemical cell or battery of cells, which responses may be captured to provide data reflecting state of charge and cell/battery quality (health) information. The technique includes specific noise reduction and small signal detection and processing capabilities to permit the use of small amplitude, non-invasive excitation signals. The technique further relates to acquiring and manipulating data to facilitate analysis and presentation of detailed information rapidly and efficiently.

In one embodiment of the invention, it may serve as the core of a cell/battery test device; in another embodiment, the invention may appear as a generalized time-domain laboratory test device such as a Time Domain Spectrometer; in yet another, it may be incorporated within a battery-related power system such as, for example, a battery charger, a battery backup system (e.g., an Uninterrupted Power System—UPS), battery conditioning system or a battery monitoring system, either to provide cell/battery status information, or as a sense/feedback subsystem incorporated within the control loop of the charger or system. The method is also particularly adapted to characterize the time-domain performance of electrical elements and networks of elements.

In one preferred embodiment, the apparatus may comprise a controlled-current source configured for connection to a first terminal of a DUT, a controlled-voltage source configured for connection to a second terminal of a DUT, a sensor configured to sense a voltage across the DUT and to produce a sensor signal in response to the voltage, and a controller connected to the controlled-current source, the controlled-voltage source and the sensor. The controller is configured to determine polarization voltages in response to the sensor signal. The controller may include a microprocessor and associated circuitry. Alternatively, the controller may be made up of analog circuitry.

Embodiments of the invention may include one or more of the following features and capabilities. The controlled-current source may be configured to provide a symmetric, bipolar square wave to the first terminal of the device. For specialized applications, the controlled voltage source may be replaced by an electrically conductive member connected directly to the common ground of the test apparatus.

Furthermore, at least one feedback loop may be employed between the sensor and the controller. The feedback loop may be configured to eliminate a non-varying or slowly varying portion of the voltage across the device (e.g., the bias voltage of the device) so that the sensor signal reflects only a portion of the voltage across the device. The controlled-current source and the controlled-voltage source may be configured to provide self-centering and auto-polarity relative to the DUT. To this end, the controller may be configured to provide self-centering relative to the device by supplying a voltage equal to one half of the bias voltage of the device to the controlled-voltage source; alternatively, an equivalent self-centering control function may be included within a sensing preamplifier.

In keeping with an important aspect of the invention, a time variant component of the voltage response of a DUT may be sampled at periodic intervals to produce a linear representation of the signal. Alternatively, a time variant component of the voltage response of a DUT may be sampled at exponentially increasing intervals to produce a logarithmic representation of the signal. Finally, a parametric sampling schedule may be used, whereby the time elapsed between successive samples is determined by a set of values programmed into prestored software. Nonlinear sampling schedules, when properly constituted to accurately capture the polarization events of interest for a particular chemistry, confer the advantage of a considerable reduction in data collection and storage requirements. In the ultimate case, only a very few data points may be required, allowing the entire method to be incorporated into a single, relatively simple, integrated circuit. Such data samples may be acquired in an automated fashion under microprocessor control.

For general laboratory applications where theoretical analysis of electrochemical reaction mechanisms is desired, time domain data may be analyzed using well known mathematical techniques, such as Fourier Transform (particularly the Discrete Fourier Transform) and Laplace Transform. The Fourier method allows derivation of a cell's equivalent frequency response, while the Laplace method is particularly suited for time-domain analysis and may be used to extract impedance and admittance information sufficient to estimate element values for an equivalent electric circuit model. Other types of non-linear analyses permit identification and quantitative characterization of the time-domain responses attributable to individual processes or mechanisms within the Device Under Test (DUT). Similarly, the voltage response of a cell under test may be captured in a form suitable for evaluation by fuzzy logic methods and neural networks.

When specifically applied to electrochemical accumulators (e.g., energy storage cells and batteries), time domain techniques may be used to assess cell condition and state of charge. Furthermore, the method is well suited for testing both rechargeable (secondary) and single-use (primary) cells and batteries of a variety of chemistries. As will be immediately understood by those skilled in the art, the method may be directly extended (through the use of properly configured excitation protocols) to provide both charging and discharging capabilities.

In accordance with the invention, the preferred excitation will exhibit at least one abrupt discontinuity, which may appear either as a step-wise transition in the amplitude of the excitation, or as a step-wise change in the first time-derivative of the amplitude waveform (e.g., its “slope”, corresponding to dV/d□, or dI/d□, for voltage-mode or current mode signals, respectively). The simplest excitation protocols will, therefore, consist of either step (e.g., a zero-current portion preceded or followed by a non-zero portion) or a single ramp that begins at zero and terminates at zero. In the preferred embodiment, more complex excitation protocols are employed, exhibiting a plurality of abrupt discontinuities. As described previously, each distinct waveform will comprise two distinct part-cycles, each taking the form of a linear segment having either a constant amplitude value or a linearly ramping value (i.e., having a constant slope), coupled together by a single intervening abrupt discontinuity as defined above.

When the excitation signal comprises a plurality of sequentially emitted waveforms, temporally adjacent waveforms will also be separated by a discontinuity. Consistent with the inventive method, this discontinuity may appear either as an abrupt step-wise transition of the amplitude, or as an abrupt change in the first time derivative of the amplitude (e.g., a step-wise change in slope), allowing various common waveforms to be developed that will include rectilinear, sloped or triangular portions, where a rectilinear waveform exhibits a fast rise-time leading edge, a segment having an substantially constant amplitude, and a fast rise-time trailing edge, and a triangular excitation exhibits at least one distinct discontinuity such as an abrupt amplitude step, or a sudden change of amplitude slope at the junction between the two linear portions. Commonly used excitation waveforms include a single step, rectangular pulses, square waves, triangle waves, constant-slope ramps, sawtooth waves (e.g., sequential ramps), sine waves, and the like.

Thus, for waveforms exhibiting such an embedded discontinuity, polarization voltage will be understood henceforth in this specification either to denote the difference between the DUT's potential just prior to the onset of a step-wise change in the excitation (viz., the leading edge of a pulse or square wave, or the apex or either end point of a triangular waveform) and the value attained at some specific later time during the excitation part-cycle. By employing high-speed synchronous sampling methods, the actual waveform of the polarization voltage that develops during each part-cycle of the excitation may be recorded for later analysis. Successive waveforms emitted during an excitation event need not be identical, and may be parametrically adjustable. However, irrespective of the particular configuration of the excitation, the sampling schedule that is employed during each part-cycle always remains synchronized with respect to the beginning of that part-cycle.

Test signals of fixed frequency (equivalently, fixed period) may be provided, as may be test signals of different frequencies (or periods). A well-defined test signal may be used to perform an evaluation of a DUT across a wide range of waveform frequencies (periods). In general, the waveforms produced may be arbitrary. That is, the waveforms may be comprised of sine waves, triangle waves, ramps, pulses, complex parametric shapes or any combination thereof, in order to assess the various time dependent characteristics of galvanically stimulated cells and electrical networks, subject only to the condition that the DUT response is acquired by a sampling means that is synchronized with an excitation means.

When galvanodynamic (i.e., current mode) excitation is used, two important special cases may obtain as well. In the case where the amplitude of the very first portion of the ‘excitation’ has zero amplitude, the voltage that appears across the DUT during this interval formally represents its initial Open Circuit Voltage (“OCV”). Note that in this case, there is no abrupt excitation discontinuity between the “open circuit” condition that obtains prior to the commencement of a test event and the initial zero-amplitude part-cycle.

For potentiodynamic (i.e., voltage mode) excitation, the equivalent zero-excitation state occurs when the driving voltage is constrained to be exactly equal to the terminal voltage of the DUT, so that no excitation current can flow.

It is also possible that the last portion of a test event will exhibit a “zero excitation”. In this case, data samples taken during this final portion will capture the relaxation behavior of the DUT, as its internal processes adjust to a final, resting equilibrium state.

According to an additional aspect of the invention, the progressive change of the polarization voltage developed across a DUT in response to a current excitation may be analyzed to yield an estimator of the condition of the DUT (for electrochemical systems, this estimator is commonly referred to as the State of Health).

By a further aspect, quantitative characterization of various underlying chemical processes, identification of anomalous (fault) conditions, and estimation of the State of Charge of an electrochemical cell or battery may be achieved through suitable quantitative analyses of the time-varying changes in polarization voltage in conjunction with information about the characteristics of the excitation (e.g., waveform parameters including magnitude, polarity, frequency, and duty cycle).

An additional aspect of invention teaches the use of the technique with electrochemical systems wherein reversible or quasi-reversible reactions occur in response to a sufficiently small excitation signal that is symmetrically applied about the instantaneous equilibrium potential of the system; in this case, the method represents a non-invasive measurement technique. While not all electrochemical systems have the property of small-signal reversibility, a significant number of commercial applications require the precise measurement and characterization of just such devices.

According to a complementary aspect, the time-varying excitation may be made sufficiently large that irreversible changes are wrought in the DUT; by this aspect, the technique intentionally becomes “non” non-invasive, in that changes wrought in the DUT persist long after the excitation has ceased. Such an excitation protocol is called for when the non-linear characteristics of a DUT are of interest. Furthermore, when the excitation provided to an electrochemical accumulator exhibits an overall time-average that is nonzero, that is, has a net positive or negative bias or trend, then-the accumulator will tend to become progressively charged or discharged, respectively, during the course of the excitation event. Thus the inventive method can serve a dual purpose, both serving to charge/discharge an accumulator, as well as providing diagnostic capabilities (via analysis of the time-domain responses of the accumulator) during the charge/discharge process itself—which diagnostics can, as mentioned previously, be used to modulate the charge and discharge processes to improve performance.

Under an expanded aspect of the invention, the method measuring and analyzing the time-dependent polarization of a cell or battery while it is being charged (or, conversely, discharged); the method may be embodied as an control mechanism to modify an ongoing charging or discharging processes, respectively. For example, a suitably large DC (or very slowly varying) charging or discharging current is provided to charge the cell/battery while a relatively small amplitude AC current (exhibiting the necessary waveform characteristics described previously) is superimposed on it to develop a distinguishable time-varying polarization voltage component across the device under charge. By removing the slowly time varying component attributable to the overall charging or discharging current, the actual time-dependent polarization voltage due to the small AC excitation may be properly analyzed. With the results of such an analysis in hand, both the speed and efficiency of a charging process may be enhanced by modifying the charging excitation during the charging process to accommodate the changing condition of the cell/battery, which condition is determined by analyzing a time-varying polarization voltage component.

According to another particular aspect, changes in the polarization voltage of a cell being charged can be used to accurately determine the end-of-charge point, which is reached when at least one of the chemical species needed for the recharge reaction has been effectively depleted, whereupon the equivalent Faradaic resistance (characteristic of the electrode-electrolyte interface) commences a precipitous change that is manifested as a commensurate change in the measured polarization voltage, and is especially apparent at relatively low equivalent polarization frequencies in the range of 1 to 0.01 Hertz. When such a rise is detected, it may be used as an indication of end-of-charge, and so employed as a stopping signal for a concurrent charging excitation.

The ability to rapidly test a cell or battery is particularly important when it will be used to supply power to a critical load, where an unexpected failure may have serious consequences. Similarly, qualification testing during and immediately after batteries or other electrochemical cells are produced, the increased efficiency of a forming/charging process mediated by information obtained according to the new method would bring new economies to battery manufacturing. The same technique may be used in the field to perform quality assurance tests prior to and after sale as well as routine preventative maintenance testing. Finally, the technique may be used in the laboratory to provide immediate information on electrochemical cell behavior under controlled conditions, to support research regarding evolving battery technologies.

The use of such a large signal excitation also is useful in certain cases, such as testing lithium or other types of primary cells, where the response of the DUT, signaling the occurrence of an irreversible change, must be evaluated to determine the condition (health) or state of charge of the cell/battery.

By yet another aspect of the invention, analyses may be performed on the synchronously sampled response data to characterize individual time-varying processes that occur in the DUT. When the successive waveforms in the excitation event are substantially identical, it is often possible to employ a point-by-point averaging technique (for samples having equivalent sampling delays in each waveform) to reduce the interfering effects of systemic noise created within the test device circuitry itself. Moreover, this technique may also be used when it is desirable to implement a test device capable of obtaining accurate in situ measurements on a cell or battery that is connected in a operating environment, and thus may exhibit externally induced ‘voltage noise signals’ across its terminals.

In general, the polarization voltage response of an electrochemical system (or a complex electrical network) is the result of a plurality of distinct response mechanisms or processes, and these individual responses add together to yield the observed response. The excitation signal represents a time-varying perturbation of the DUT, and hence the individual constituents of the response are each indicative of the establishment of a new equilibrium condition for an individual process (within the DUT) that was affected by the perturbation. In many cases, this path to a new equilibrium may take the form of a decaying exponential function. Suitable analyses may be performed to extract the parameters (time constants and amplitude coefficients) that characterize such functions.

In accordance with another aspect, an apparatus suitable for performing the method may comprise: at least a current driver and current receiver jointly operative as a means to provide an excitation to a DUT; a sensing means operative to detect a response developed in the DUT by the excitation; a sampling means properly disposed for acquiring digital samples of the response signal according to a sampling schedule and operating in synchrony with the excitation means; a control means disposed to control the excitation means and sampling means, and accomplish any subsequent data analysis that may be desired. A means may also be provided for achieving a self-centering function, whereby the bias voltage of the DUT is determined, and used to adjust the output voltage presented by the current receiver so that the relative potentials of the DUT's two terminals may be adjusted to appear centered with respect to the common ground potential of the apparatus. In one preferred embodiment, the controlled-voltage source may be controlled to produce a voltage having a magnitude equal to one half of the bias voltage of the DUT.

In yet another general aspect, the invention teaches that polarization voltage responses developed within a DUT by virtue of the application of an excitation signal applied to the DUT by connecting a controlled-current source to a first terminal of the DUT, connecting a controlled-voltage source to a second terminal of the DUT, and using a controlled-current source to apply a bipolar, symmetric square wave to the DUT may be realized. A voltage, representing a response signal, is sensed across the device to produce a sensor signal, and the sensor signal is modified to eliminate effects of a non-varying or slowly varying portion of the sensed voltage, such that the resultant modified sensor signal substantially corresponds to the time-varying polarization voltage response of the DUT. Provided that the amplitude of the excitation is sufficiently small, this represents a “non-invasive” test method.

When this technique is used to test batteries, immediate assessment of condition and relative state of charge can be made by plotting deviations from the mean values. Mean value (i.e., “benchmark”) data is obtained from measurements of many known-good cells of the particular type. The deviations from these mean values obtained for the cell under test are then calculated to produce the equivalent of a fingerprint that can be interpreted visually, either by a human operator or by a computer look up table or algorithm, to achieve qualitative understanding of the cell's condition and state of charge. The polarization voltage may be compared to baseline data for a class of devices to which the device belongs to assess a relative condition of the device. Specific differences in the shapes of the response patterns are indicative of specific problems or changes within the device under test and, for specific types of devices under test, only certain data points, corresponding to specific polarization frequencies (where polarization frequency is defined as the inverse of the particular sampling delay interval), need be evaluated to make the necessary determination.

For example, detection of asymmetry (i.e., hysteresis) between positive and negative half-cycle responses may arise from a process described by a nonlinear transfer function, indicative, for example, of semiconductor diode behavior within a cell electrode; this effect appears, for example, in severely discharged and heavily sulfated lead-acid cells. The technique may be used effectively with many different types of energy accumulators and chemistries; for example, the relative age of lithium ion cells (number of charge/discharge cycles experienced) can be estimated from relative separation and changes of polarization curves when cells are otherwise equated for open circuit voltage.

The technique facilitates rapid acquisition and analysis of energy cell state of charge and overall condition. The inventive apparatus may be configured to permit ease of use and efficient, portable operation. An apparatus according to the technique may include a self-centering and polarizing circuit with respect to connection of test leads to a DUT that exhibits an intrinsic bias potential, as is typical of a charged accumulator. To this end, the circuitry may include four connectors that include test leads each supplied with suitable connecting clamps, clips or fixturing. The connectors are affixed to terminals of the DUT, so that the connection for the non-inverting sense preamplifier input and the current drive signal are made to one terminal of the DUT, while the connections for the inverting preamplifier input and the current receiver signal are made to the opposite terminal of the device under test. This connection method is known as a Kelvin connection.

By a further aspect, the overall voltage response signal of a cell under test may be processed to remove from that signal a time-invariant component to isolate a time-variant component, thus providing a DC offsetting function, whereby compensation for the substantially static bias voltage of DUT may be applied to the detected signal, so that the time-varying polarization component can be separately measured with improved accuracy. By an extension of this method, this offsetting compensation may be readjusted during the course of an excitation event, to accommodate for very slowly varying DUT bias voltage changes due to any overall charging or discharging of the DUT that may occur, either as a result of an asymmetric test excitation configuration or the intentional application of charging or discharging current.

To improve testing efficiency, cell excitation and response data may be acquired in an automated fashion under microprocessor control. This data may be acquired and stored in a format useable by an associated data processing device. A graphical transformation of cell voltage response data may be implemented, and the transformed data provided on a display means, to facilitate evaluation and analysis of state of charge and overall cell condition.

The invention provides an accurate method of testing and qualifying electrochemical devices, and so promises to help meet an ever growing need for such devices that can reliably deliver electricity on demand, and in many cases, be quickly and easily recharged for further use. Such devices include fuel cells, primary (single use) cells and batteries, and secondary (rechargeable) cells and batteries. There is a commensurate need for a technique for rapidly evaluating the state of charge and overall condition of such a device, regardless of whether the device is in a static (disconnected) or dynamically operating (charging/discharging) condition.

### BRIEF DESCRIPTION OF THE DRAWINGS

The objects and features of the present disclosure, which are believed to be novel, are set forth with particularity in the appended claims. The present disclosure, both as to its organization and manner of operation, together with further objectives and advantages, may be best understood by reference to the following description, taken in connection with the accompanying drawings, as set forth below.

FIGS. 1A-1D disclose block diagrams of the test device according to the present disclosure;

FIG. 2 is a block diagram illustrating a centering effect of the test device of FIGS. 1A and 1B;

FIGS. 3A and 3B are respective graphs of a single frequency-driving signal used to evaluate a cell under test and a nominal cell potential;

FIGS. 4A and 4B are graphs of a voltage response across a cell under test;

FIGS. 5A and 5B are graphs of a voltage response across a cell under test;

FIGS. 6A-6C are graphs of a half cycle of the voltage response across a cell under test;

FIGS. 7A and 7B are graphs of a tester output signal;

FIG. 8 is a graph of a logarithmic map of a tester output signal;

FIGS. 9A and 9B are graphs of a tester output signal;

FIG. 10 discloses an excitation signal;

FIG. 11A shows a plot of test protocol data for 255 cycles;

FIG. 11B shows a plot of extrema points;

FIG. 11C shows overall envelope amplitude plots;

FIG. 11D shows overall envelope amplitude plots;

FIG. 12A shows a linear plot of raw data;

FIG. 12B shows an exponentially decimated data plot;

FIG. 12C shows a raw data plot with a linear time scale;

FIG. 12D shows an exponentially decimated data plot;

FIGS. 13A-13C show raw data plots;

FIG. 13D shows a plot for the entire protocol;

FIG. 13E shows a plot of the amplitude envelop signature of the cell;

FIG. 13F shows an initial waveform plot of an exponentially increasing inter-sample time transformation;

FIG. 13G shows a final waveform plot of an exponentially increasing inter-sample time transformation;

FIG. 14 shows a data plot of discharge test protocol;

FIG. 15A shows a data plot 24 hours after final discharge event;

FIG. 15B shows a data plot 24 hours after final discharge event;

FIG. 15C shows a data plot 24 hours after final discharge event;

FIGS. 16A-22C show data plots;

FIG. 23A shows a plot of lower extrema data;

FIG. 23B shows a plot of lower extrema data;

FIG. 24A shows a plot of upper extrema data; and

FIG. 24B shows a plot of upper extrema data.

### DETAILED DESCRIPTION OF THE INVENTION

The method of the invention may be embodied a variety of ways, each utilizing a variant of the apparatus. Many features and advantages of the invention may be apprehended from the following description and drawings of several preferred embodiments, which are individually and separately discussed below. Moreover, it will become apparent to one skilled in the art that other useful embodiments of the methods and apparatus may be employed; the scope of the invention is only limited by the appended claims.

Method Variant #1

It is often desirable to ensure that the test performed on an electrochemical system or cell (or battery of cells) is non-invasive in nature, such that the condition of the cell after the test event has been completed is substantially equivalent to its initial condition. To achieve a non-invasive test, two criteria must be satisfied: the time average of the excitation when computed over the entire duration of the excitation event must be zero; and, the amplitude of the excitation waveform(s) is sufficiently small that it does not cause any substantial irreversible reactions to occur during the test procedure. In one preferred embodiment, these criteria are achieved by using an low amplitude excitation comprising a bipolar square wave current exhibiting a 50% duty cycle, (each of the two parts of a cycle have the same duration, yielding a mark-space ratio=1); additionally, each of the part-cycles have amplitudes that are substantially equal in magnitude but of opposite polarity, so that the average DC current component of the excitation is exactly zero. The magnitude of the excitation current is adjusted so that the resultant polarization voltage response developed across the cell never exceeds more than several tens of millivolts. The response is periodically sampled in a synchronous manner during each half-cycle of the excitation sampling, such that the same number of samples are acquired during each half-cycle, and within each half-cycle, the k^{th} sample is always acquired at a precise interval, ΔTₖ, measured with respect to the beginning of the half-cycle (as defined by the corresponding abrupt edge transition); the point in time where each response data sample is acquired (e.g., ΔTₖ) remains under the control of a pre-determined sampling schedule.

The effective signal-to-noise ratio of the data may be improved by a point-by-point averaging technique whereby the sums of corresponding sample points (e.g., each of the k^{th} samples) from consecutive positive half-cycles are computed, while the corresponding sums for the negative half cycle data points are computed separately. These sums are then each divided by the number of samples (N) yielding averaged values exhibiting a “Square Root of N” noise reduction factor. The averaged data, which may be represented as curves possessing a characteristic shape and size, may be then analyzed or transformed as required to yield detailed information about the condition and future performance of the electrochemical system,-cell or battery of cells. Several types of sampling schedules may be employed, whereby the samples may be evenly spaced in time (a linear schedule), or non-linearly space (e.g. where the delay of each successive sample is determined by an exponential series); additionally, sub-sampling may be performed on previously acquired data as required. Linearly sampled data is suitable for processing with integral Laplace and Fourier transforms (to improve accuracy and reduce processing time, it is preferable for the total number of data points analyzed within each half-cycle to correspond to an even binary number), while exponentially sampled data is useful for immediate graphical presentation of test results (and, coincidentally, yields a significant reduction in data processing load).

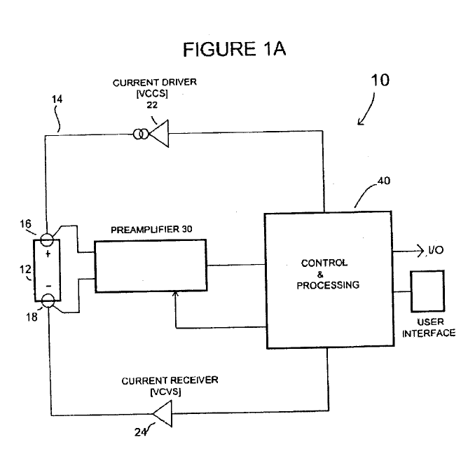

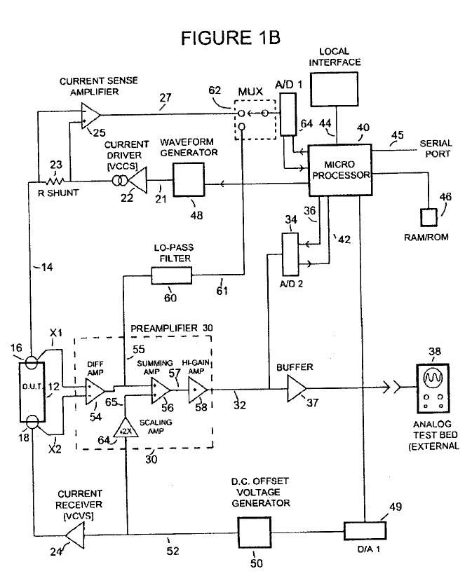

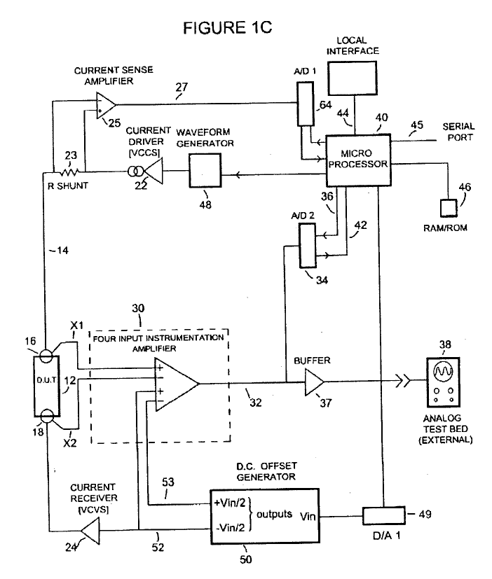

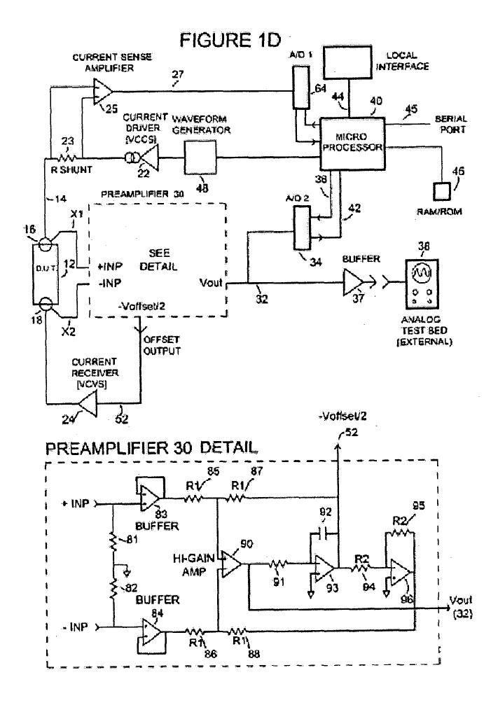

One preferred embodiment of the invention will now be described. Referring to FIG. 1A, a tester 10 develops a time varying polarization voltage across Device Under Test 12, and detects, measures and processes the polarization voltage. DUT 12 conventionally has two electrical terminals, which are hereinafter designated as positive terminal 16 and negative terminal 18. Current signal 14 is imposed across DUT 12 by current driver 22. Current driver 22 may include conventional components. In one implementation, current driver 22 comprises a voltage controlled current source, although other types of controlled current source may be employed. In general, current driver 22 must be capable of producing a sustained bipolar current drive signal 14, which takes the form of a precise square wave. Current driver 22 is electrically connected to one terminal of DUT 12. The opposite terminal of DUT 12 is similarly connected to current 24, which may incorporate a voltage controlled voltage source. Current receiver 24 exhibits negligible output impedance (for all frequencies of interest, viz., including a sufficient number of high-order harmonics to properly define an edge corresponding to an abrupt amplitude transition), so that it serves as a virtual AC ground suitable for receiving the excitation current passing through the DUT from current driver 22. In the preferred embodiment, current receiver 24 is preferably implemented as an active circuit element comprising a voltage controlled voltage source, but this active circuit element may be replaced by a direct connection, via an electrically conductive member, between the DUT and the common ground circuit of the test system. Preamplifier 30 also is connected across the terminals of DUT 12, which preamplifier senses, isolates, and amplifies the polarization voltage induced across the internal impedance of DUT 12 by drive signal current 14 supplied by driver 22. System control, data processing and I/O functions are provided by microprocessor 40, such as an Intel 80386 processor, and associated analog and digital components; in an alternate embodiment, some or all of these functions may be rendered in the form of analog computing and control circuitry. Furthermore, the excitation and sampling parameters may be adjusted according to control signals or commands received for either Local Interface 44 or communications port 45 (FIG. 1B).

Kelvin Connection and Signal Detection

Kelvin connection circuitry may be used to attach the components to the device. The Kelvin connection circuitry may include a first lead connected to the controlled-current source and configured for connection to the first terminal of the device, a second lead connected to the controlled-voltage source and configured for connection to the second terminal of the device, and third and fourth leads connected to the sensor and configured to be connected to, respectively, the first and second terminals of the device. This apparatus configuration is now described in detail.

In FIG. 1A, DUT 12 is connected to the tester 10 using four electrically conduction members (e.g., test leads) connected so that each lead makes an individual connection directly to the appropriate terminal of the device 12; thus, each connection to current driver 22, current receiver 24, and preamplifier 30 are effected through separate circuits. This connection method, known as a Kelvin connection, reduces the interaction between the driving circuitry (i.e., current driver 22, current receiver 24, and their associated connection leads) and the sensing circuitry (i.e., preamplifier 30 and its associated connection leads). By virtue of the direct connection of the preamplifier test leads to the terminals of device 12, and the relatively high input impedance of preamplifier 30, no drive current flows through any part of the sensing circuitry comprising preamplifier 30, so that the detected polarization voltage is completely attributable to response elicited in DUT 12 by the excitation. Referring to FIG. 1B, detection and analog processing of the polarization response signal is provided by preamplifier 30, which may include four operational amplifiers 54, 56, 58 and 64 to accomplish voltage sensing, DC offset compensation, and amplification functions of the preamplifier 30. Terminals 16 and 18 of DUT 12 are electrically connected to respective positive and negative inputs of instrumentation amplifier 54, which may take the form of a differential amplifier having a very high impedance, unity gain, and excellent common mode rejection. The output, signal 55, produced by instrumentation amplifier 54 is equal (or, if amplifier has other than unit gain, is linearly proportional) to the potential difference between the inputs of the amplifier 54. When device 12 is an electrochemical cell or battery of cells having an intrinsic DC bias potential of its own, signal 55 will initially comprise the sum of this DC bias potential plus a polarization voltage component that is developed across the internal impedance of DUT 12 by drive current 14.

Because the signal of interest is only the relatively small polarization voltage component of the full measured device potential, it is useful to remove the effects of any DC bias component from the output of preamplifier 30. This is accomplished using an offset generator 50 that supplies a suitable DC offsetting voltage signal 52 to an inverting scaling amplifier 64. Summing amplifier 56 combines the inverted offset voltage produced by scaling amplifier 64 with signal 55 to produce signal 57; by this means, the effect of the DUT's bias voltage are removed from signal 57, so that it corresponds to only the polarization voltage component of the full potential appearing across DUT 12. In the embodiment depicted in FIG. 1B, the value of the offset voltage is ultimately determined by microprocessor 40, which controls D/A 1 (a digital to analog converter) that in turn controls DC Offset Voltage Generator 50.

As noted, preamplifier 30 provides an output signal 55 substantially equal to the total potential present between the terminals of device 12. This output is conveyed to a low-pass filter 60 that is configured to remove higher frequency components from the signal 55 to provide a filtered DC voltage 61 to a multiplexer (MUX) 62. The microprocessor 40 controls the MUX 62 to route this signal to an A/D converter 64 that in turn conveys a digital representation of the signal 61 to microprocessor 40. The microprocessor then issues digital commands to offset voltage generator 50, which may include a digitally-controlled voltage source. Offset voltage generator 50 responds by providing offsetting voltage 52 having a magnitude equal to one half of the DC potential present across DUT 12, and having the same relative polarity as terminal 18 of device 12.

Offsetting signal 52 is conveyed to scaling amplifier 64, which amplifies this signal by a factor of negative two to produce output 65 that, by virtue of the microprocessor's program, equals the DC component of signal 55 in magnitude, but is of opposite polarity. As noted, signals 55 and 65 are conveyed to summing amplifier 56, which sums them to produce signal 57. This, in effect, subtracts the DC bias component 65 from signal 55 to remove the DC component associated with any intrinsic DC potential present in device 12 and thereby isolate the polarization voltage component as signal 57. Signal 57 is thereafter provided to the input of a high gain amplifier 58, which has an amplification factor of about 1500, to produce polarization voltage output 32 that represents the signal of interest in a form conveniently used by digital and analog instruments.

Signal 32 is conveyed to unity gain buffer 37 that provides an isolated output for test bed instrumentation, such as an oscilloscope or other visual display device. The buffer prevents interaction between preamplifier 30 and the analog instrumentation 38.

Digitization of Polarization Signal

Signal 32, representing the isolated and amplified polarization voltage, is supplied to A/D converter 34 that converts analog signal 32 into digital signal 36 comprising a series of digital samples. Converter 34 is controlled by microprocessor 40, which forwards clock signal 42 to the converter, which is commanded to acquire a sample of its input, signal 32, during each clock cycle. Each digital sample substantially represents the instantaneous value of signal 32 at a point in time corresponding to a clock pulse. Digital signal 36 is passed to microprocessor 40 for processing, storage and, as required, for transmission via serial port 45.

Auto Centering/Auto Polarity Function

Offset signal 52 is also used to provide a self-centering effect. Signal 52 constitutes the input signal to current receiver 24, and, as noted above, is set by microprocessor 40 to have one half the magnitude of the DC bias voltage of DUT 12 with the same relative polarity. A primary attribute of the current receiver 24 is that its output voltage is maintained at a level equal to its input voltage, irrespective of the output load current. This means that terminal 18 of device 12, which is connected to current receiver 24, will be maintained at a voltage equal to one half of the total DC bias of device 12, having a polarity equal in sign to the actual polarity of terminal 18 of device 12, as determined previously by the microprocessor 40. Because the output of current receiver 24 exhibits a very small impedance, its output voltage appears as a virtual ground, such that it does not exhibit any variations due to the reception of the time-varying excitation current received through DUT 12.

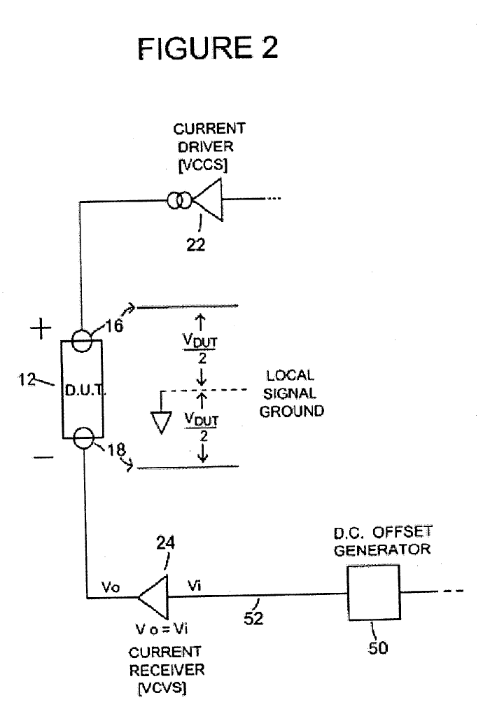

Terminal 16 of DUT 12 is electrically connected to current driver 22, which is a voltage controlled current source exhibiting very high output impedance. As such, the output of current driver 22 will assume whatever voltage potential, with respect to the relative potential of DUT 12, is required to ensure delivery of the proper output current as is functionally determined by its controlling input signal 21. Thus, by employing both virtual ground current receiver 24 that maintains at its output a DC potential determined by the microprocessor, along with a highly compliant current driver 22, the DC bias voltage presented by the DUT 12 is, in effect, centered with respect to local signal ground, as shown in FIG. 2. For example, if DUT 12 has a DC bias voltage of six volts, the positive terminal 16 of DUT 12, which is connected to current driver 22, will be three volts above ground, while conversely, its negative terminal 18 will be three volts below ground. This self-centering capability offers great advantages for portable implementations that operate using a battery pack power supply. By ensuring that the cell voltage will be centered about signal ground, the total battery pack voltage that is necessary to ensure proper operation of the electronic circuitry is thereby minimized. Furthermore, this arrangement makes the relative polarity of the connections between the test system and the terminals of DUT 12 irrelevant, provided only that signals 14 and X1 are connected to one terminal of the DUT and signals 18 and X2 are connected to the other terminal. Thus, if device 12 is attached to the system with its negative terminal 18 connected to current driver 22 and its positive terminal 16 connected to current receiver 24, the control loop described by preamplifier 30, low pass filter 60, multiplexer 62 A/ID converter 64, and microprocessor 40, will produce an offset voltage signal 52 of the same polarity as terminal 16 of DUT 12. That signal serves as the input to current receiver 24, which then presents that voltage and polarity back to DUT 12, properly matching the polarity of DUT 12 and thereby centering the DC bias voltage of DUT 12 about the local signal ground.

Generation of the Excitation Signal

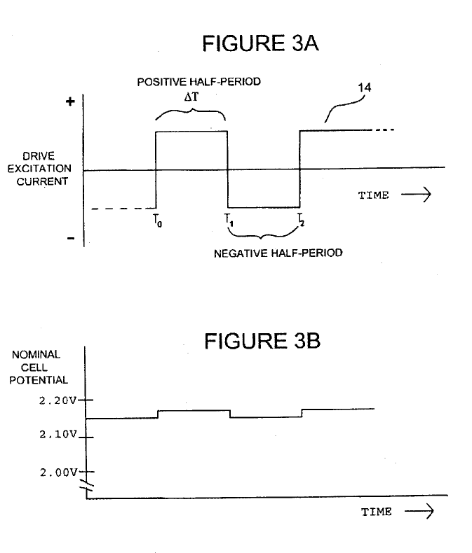

Control signal 21 for current driver 22 is provided by Waveform Generator 48, under control of the microprocessor 40. The control signal takes the form of a precise square wave voltage signal having several important characteristics, as depicted in FIG. 3. A primary characteristic of this signal is that is exhibits symmetry about the horizontal (time) axis. As indicated in FIG. 3, a single cycle of signal 14 may be subdivided into two distinct half-periods of equal duration. The positive half-period from T₀ to T₁ and the negative half-period from T₁ to T₂ must be of equal and constant duration for each full cycle of the waveform. By ensuring that the duty cycle of each square wave is 50%, accurate charge balancing will be achieved over the course of each waveform cycle, and additionally, the half-cycle timing variance (skew plus jitter) within a whole cycle should preferably not exceed 20 nanoseconds. Similarly, the signal magnitudes during each half of single cycle must be equal. By ensuring symmetry both in the amplitude and time domains, the galvanic excitation provided to DUT 12 will have a net DC current value of zero when summed over an integral number of cycles. The amplitude and the frequency of signal 14 may take on a number of different values, but to ensure that the drive signal does not significantly alter the state of charge of DUT 12, the amplitude is advantageously set so that the peak to peak value of the polarization voltage produced across device 12 does not exceed several millivolts per individual cell (viz., the excitation is adjusted to be sufficiently small to ensure that no irreversible reactions occur within the cell during a test event), and furthermore that precisely an integral number of cycles are generated at each specific frequency. To ensure detection of a very fast process or phenomenon within DUT 12, it is necessary that the rise time of the square wave drive current exceed, by a substantial margin, the response time of the fastest process to be detected; otherwise, the measured response will reflect only the properties of the driving signal and circuitry, not those of the device under test. Hence, it is preferred that the square wave rise time be on the order of one microsecond, in order to ensure that an accurate and measurable polarization response is created.

To allow direct determination of current output of current driver 22, current sensing resistor 23 is connected in series with the output of current driver 22. The drive current passes through this resistor, developing a proportional voltage, which is detected by differential input current sense amplifier 25, whose output 27 connects to multiplexer 64, which is under the control of microprocessor 40. At various times, the multiplexer may be switched to route current sense signal 27 into A/D converter 64, whereupon the digitally sampled drive current information is conveyed to the microprocessor for processing and storage.

Microprocessor Funtions

Microprocessor 40 is a stored program microprocessor commercially available such as the Intel 80386 processor; however, the use of other microprocessor types is contemplated for specific applications. Microprocessor 40 provides outputs to, and accepts inputs from, user interface 44 which may include a keypad and visual display. Microprocessor 40 is further provided with a standard serial interface 45 to permit data exchange between the system and an external computer or other digital device. Microprocessor 40 is responsible for overseeing and managing the operation of the overall system. Microprocessor 40 may also be provided with random access memory 46 of conventional design, and other supporting devices as well, to permit the storage and manipulation of user inputs, data and outputs.

Method Variant #2

Variations on the circuit of FIG. 1B, representing alternate embodiments of the inventive apparatus, are provided in FIGS. 1C and 1D. FIG. 1C illustrates a variation in which preamplifier 30 is implemented using a four input instrumentation amplifier. FIG. 1D illustrates an implementation in which the microprocessor no longer provides control for the self-centering function; instead, novel analog circuitry is incorporated within the preamplifier itself whereby self-centering may be achieved.

In the implementation of FIG. 1C, the DC offset voltage generator 50 develops two voltage signal outputs 52, 53 in response to an analog input control signal. These outputs are each equal in magnitude to one half of the magnitude represented by the input control signal, but are of opposite polarity (e.g., V_{OUT1}=(+V_{IN}/2); V_{OUT2}=(−V_{IN}/2)). In this variant, preamplifier 30 is equipped with four voltage input terminals and one output terminal, the first two inputs (designated A and B) are of a non-inverting sense with respect to the output signal, and the second two inputs (designated C and D) are of an inverting sense with respect to the output signal. The output signal is a voltage that includes a highly amplified copy of the algebraic sum of the four input voltage signals (i.e., V_{OUT}=k(A+B−C−D)).

Microprocessor 40 may commence a preprogrammed sequence of operations, either as a result of a user input command, or (in the case of an automatic instrument embodiment) as a result of detecting a change in the voltage present across the two preamplifier input circuits. Such a voltage change signals the completion of a suitable connection to an external device under test.

The preprogrammed sequence may have an initial function of providing a proper control signal to a DC offset generator so as to null out the effect on the preamplifier's output due to the bias voltage present across the terminals of the DUT, and to center the bias potential exhibited by the DUT about local analog ground. This may be achieved as follows. First, the controller receives a sense signal, via analog-to-digital converter 34, that is representative of the voltage output of the preamplifier and is of the same polarity, but substantially amplified in magnitude, as the potential present across the externally connected preamplifier input circuits, due to the intrinsic bias of the DUT. Next, in response to this sense signal, the controller, via a digital-to analog converter 49 (D/A 1), commences outputting a constantly increasing control signal to the DC offset generator. The control signal has the same relative polarity as the output of the preamplifier, and continues to increase in magnitude as long as the output of the preamplifier is other than zero. In effect, this represents the behavior of an ideal non-inverting integrator. The output of the DAC is conveyed to the input of the DC offset voltage generator. The DC offset voltage generator is provided with two outputs having absolute magnitudes that are always the same and equal to one half of the magnitude of the controlling signal, but are possessed of opposite relative polarity. The negative output, of opposite polarity to the generator input, provides the controlling input to the current receiver. Both outputs are connected to the preamplifier, such that the positive output is connected to preamplifier input, which has an inverting sense, and the negative output, of opposite polarity to the generator input, is connected to preamplifier input, which has a non-inverting sense. Thus, provided the voltages presented by the DC offset generator will algebraically cancel the voltage presented by the device under test, the DC potential of the preamplifier output will be zero.

If for example, the DUT is connected so that its positive terminal is connected to both the current driver and the positive input of the preamplifier input, and conversely, its negative terminal is connected to the current receiver and the negative input of the preamplifier, the output voltage of the current receiver will be seen to become increasingly negative (in response to the control signal emitted by the microprocessor) with the passage of time, forcing the DUT's negative terminal, which was initially at ground when the test event was commenced, to assume an increasingly negative value. Note that the positive terminal of the DUT is connected to two high impedance nodes (e.g., a high impedance preamplifier input and a high impedance current source). As such, though the intrinsic bias potential of the device under test remains constant, the relative potential of its positive terminal will appear to become increasingly negative with respect to the ground potential of the overall circuitry.

The output of D/A 1 49 will continue to slew until the voltage presented at the output of the current receiver, as provided by the DC offset generator, is equal in magnitude to one half of the intrinsic bias potential of the DUT, and of the proper polarity such that the algebraic sum of the four preamplifier inputs will be precisely zero, leading to a preamplifier DC output of zero. At that point, the input to the non-inverting integrator (which in this embodiment is not present as a discrete circuit constituent, but is instead simulated by the operation of the microprocessor response to the output of the preamplifier) becomes zero, and accordingly, the output of the simulator integrator ceases to change. This in turn causes the slewing of the output of D/A 1 to cease.

The net effect of this differentially configured integrator servo control loop is twofold. First, regardless of the actual connection of the test leads, provided they are connected in the proper pairwise fashion as previously noted, the loop action will cause the bias potential of the device under test to be precisely centered about local analog ground. Second, the DC bias of the device under test with respect to the preamplifier's output effectively becomes nulled out, allowing very small polarization signals, present differentially across the terminals of the DUT, to be highly amplified by the preamplifier and still appear centered within its effective output dynamic range.

This technique has the further benefit of allowing a substantial decrease in the required power supply voltages (with the attendant decrease in cost, and in the case of portable embodiments, a substantial decrease in size and weight) which are required to accommodate a device under test of given bias potential, as compared to traditional DC coupled methods wherein the relative potential of one terminal of the DUT remains fixed at relative ground, while the other terminal may appear either above or below ground by an amount equal to the relative bias voltage, depending on the polarity of the test lead connections. Of course, the problem of polarity could be simply avoided by employing capacitive coupling techniques, but this severely affects the accuracy of any measurement at low frequencies. Specifically, it renders measurement impossible for excitation signals characterized by relatively long duration half-cycles of constant amplitude, each of which half-cycles represents a temporary DC signal condition that cannot be properly detected via a capacitively coupled sensing means.

The offset generator may be configured to provide either a fixed DC offsetting signal or a tracking DC offsetting signal. The signals output by the offset generator may then either be held at a fixed value (representing fixed DC bias offsetting) throughout the duration of a test event, or may vary (representing a tracking DC bias offsetting method) under control of the microprocessor (as it varies the output provided by its embedded virtual integrator) during the test event. This latter method allows the test device to compensate for changes in the bias voltage of the DUT caused by charging or discharging currents from some external source, or as a result of any other long-term variation in the bias potential of the DUT. Suitable algorithmic corrections can be applied to the polarization voltage data to compensate for the distortions created in the polarization voltage data as a consequence of the bias tracking operation.

In the implementation of FIG. 1D, a variant is depicted wherein the bias generator function, that provides the DC offsetting capability, is incorporated within the analog circuitry of the preamplifier itself. Resistors 81 and 82 are optional, and may be installed if desired to provide bias currents to buffers 83 and 84. Buffers 83 and 84 are unity gain amplifiers that exhibit high input impedance so as not to load, or draw current from, DUT 12. Resistors 85-88 may have values of about 2000 ohms, with values matched to within 0.01 percent to provide adequate common mode rejection; this can be readily achieved with monolithic resistor networks (suitable trimming resistors may be used as well, to mitigate the tight tolerance specification). Amplifier 90 is of the high gain instrumentation type, having high impedance inputs. Amplifiers 93 and 96 constitute with their associated componentry (particularly with respect to resistors 94 and 95, which are very well matched so that amplifier 96 behaves as a highly accurate unity gain inverter) a differential output integrator, having the known characteristic that its outputs will remain constant provided its differential input is zero. The differential integrator outputs are connected to resistors 87 and 88, in a manner that the integrator outputs will automatically adjust to force the net DC value of the preamplifier output to always maintain a zero value (that is, be always equal to the potential provided at the non-inverting inputs of amplifier 93 and amplifier 96). The time constant of the integrator comprising elements 91, 92 and 93, is set by the product of resistor 91 and capacitor 92, and must be adjusted so that the lowest input frequencies of interest are not substantially attenuated. In an alternate configuration, this time constant may be made adjustable under external control, as, for example, by the use of a digitally controlled resistance element in place of resistor 91, to properly accommodate any change in the intrinsic voltage of DUT (which, for example, could be due to the fact that DUT is being charged or discharged during the test event).

Description of Synchronous Sampling Method and Analysis Algorithms

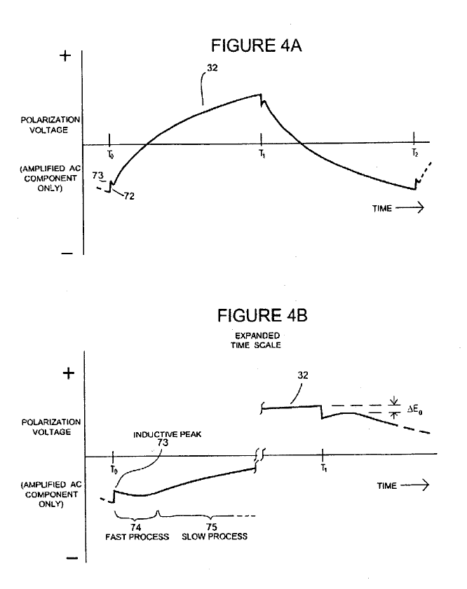

Polarization voltage signal 32, depicted schematically in FIGS. 3 and 4, represents the voltage response developed across a typical electrochemical DUT by the square-wave drive current. Because the drive current signal is symmetric and periodic, and of sufficiently small amplitude to ensure linear response in the DUT, the resultant polarization voltage will exhibit similar symmetries. In most cases of interest, particularly for electrochemical accumulators, the polarization response exhibits several recurring characteristics. At time To, corresponding to the abrupt positive transition of the drive current, the polarization response undergoes a similarly rapid change. Due to the very short rise time of the square wave drive current, this stepwise change of the response accurately represents a (nominally) time-invariant part of the polarization voltage, and is therefore attributable to the value of the ohmic (that is, real) component of the device's impedance, which is easily calculated from the known excitation current and the magnitude of the observed voltage step by the formula R=E/I. When this values is computed for an electrochemical accumulator represented by an energy storage cell or battery, it is commonly referred to as the “resistance” of the cell/battery.

From a physical perspective, this resistance comprises several components that appear arrayed as elements of a series connected electric circuit, which elements may, for example, include the actual resistance presented by the interconnecting conductors within the cell, the effective resistance presented across the thickness of the active material region on the electrode surfaces, and finally, the effective electrical resistance attributable to the electrolyte within the cell. For many chemistries, these resistive components change only slowly throughout the life of a cell and exhibit a ‘locally constant’ value (at a given point in the cell's life) that is substantially unaffected by the cell's state of charge; for other chemistries, notably lead-acid, the apparent resistance of a cell is strongly (and often monotonically) related to the cell's state of charge, such that this resistance value may exhibit a substantial increase as the cell approaches a discharged state. In light of these clarification, it should be understood that when a cell is stimulated with a current step, the abrupt voltage step observed is characterized as time-invariant specifically with respect to the time scale of the current step itself, which is assumed to be much shorter than the time required to make any significant change in the cell's state of charge, since it is known that the value of this resistance may change appreciably for certain chemistries as a function of state of charge, and may therefore be used as one parameter in cell analysis algorithms. It should also be observed that an often overlooked component (and sometimes quite significant) of the real resistive component observed for a cell under test is the resistance attributable to the test connections themselves; in a real-world battery application, this type of resistive component is referred to as the terminal connection resistance. If this resistance becomes excessive, the operation of a real-world system can become compromised. It becomes quite useful, therefore, to be able to immediately determine the cell resistance using the inventive method, by measuring the polarization voltage response developed across a sub-system comprising a cell plus at least one of its terminal connections, and extracting the time-invariant component of the response.

As can be seen in the figures, there may also be a small overshoot in the observed polarization voltage response, due to the combined inductive characteristics of the DUT and the test fixturing itself. Proper attention to fixturing will reduce stray inductances to negligible levels and allow the DUT's own inductive response (which typically lasts from one to several hundred microseconds) to predominate.

Immediately following the decay of any inductive overshoot and for the remainder of the half cycle, the response is seen to increase monotonically in magnitude in a non-linear fashion (unless the device appears purely resistive, leading to a simple flat topped square wave response). In particular, the slope (first derivative) of this curved response is seen to progressively decrease throughout each half-period, and is recognizable as being similar to the well known exponential function (1-e^{1/t}), which is used to describe electrical circuits containing resistive and capacitive elements. This curved portion will hereinafter be referred to as the time-varying component of the polarization response.

It is often useful to take the value of the excitation current (which is by assumption held constant throughout the flat topped portion of an excitation half-cycle or pulse) along with each instantaneous (that is, discretely sampled) value of the time-varying component of the polarization voltage (that is, as distinct from the time invariant component defined above) and compute, by a direct application of Ohm's Law, a set of values for the apparent polarization resistance as it evolves during the flat-topped excitation portion; these computed values may be used as parameters in cell analysis algorithms. It will be apparent as well, that such algorithms might include computations, using pairs of values, of the rate of change of the polarization resistance, (APR/At), which computed values may in turn be used to estimate various battery indicators such as state of charge and state of health, and be used to identify specific fault conditions. A precipitous amplitude change in the response signal that is not correlated with a simultaneous abrupt change in the excitation can be indicative of the creation of (or the dissolution of) a spurious low impedance connection such as a ‘whisker’ or metallic dendrite across a normally highly-resistive interface region within a cell.

A plot of the of the time-varying component of the polarization voltage as it evolves during the constant portion of a current pulse is often observed to exhibit at least two distinct regions, arising from processes having widely different characteristic time constants. These portions are identified in FIG. 4B as the fast (74) and slow (75) processes, respectively, and exhibit commensurately differing curvature. Fast processes tend to expend themselves in the early part of each half-cycle, while the later tail section takes its shape from slow processes and so changes relatively gradually over time.

At T₁, the next stepwise current transition occurs, whereupon a polarization curve of similar shape appears, but now tending downward. Provided that neither the condition nor state of charge of the DUT changes appreciably during several consecutive excitation periods (i.e., the square wave cycles), it is apparent that the shape and size of overall response waveform will also remain relatively constant. In general, the polarization voltage signal is well behaved and, except for a discontinuity at each stepwise edge transition, is continuous.

The polarization response is digitized by converter 34, according to a sampling schedule controlled by the microprocessor 40, and synchronized with the excitation. To accurately capture all the details of an arbitrary waveform, digital sampling theory teaches that the sampling rate must be at least twice as high as the highest frequency component of interest to avoid aliasing errors, and in practice, ten-times oversampling is used to ensure the fidelity of the digitized waveform.

Conventional digitization techniques employ a fixed interval sampling schedule (e.g., the time interval δt between samples remains constant throughout a test event) wherein the analog wave form is repeatedly sampled and digitized, synchronously with a sample clock control signal having a constant frequency (f=1/δt). As is well known to practitioners of the art, constant δt sampling is preferred if the data is to be analyzed using discrete transforms (Laplace or Fourier). The attainable resolution of such transform analyses is limited by the magnitude of δt, in that decreasing δt (that is, increasing the sampling rate) allows faster processes, or equivalently, higher component frequencies, to be resolved. Since typical electrochemical cells often exhibit transient responses in the microsecond range, particularly when excited by a square wave current (i.e., galvanodynamic excitation), it would appear that a very high sampling rate is preferred. Furthermore, when testing electrochemical accumulators whose behavior is governed in part by relatively slow kinetic processes such as diffusion, a very low frequency square wave excitation (0.1 and 0.01 Hertz) is required to elicit a significant polarization response.

When such a slow waveform is repetitively sampled at a high rate, a very substantial number of digitized values will be accumulated, especially if the test procedure includes many cycles of the waveform to ensure adequate noise averaging, or to validate the assumption of invariance over repeated cycles. For many applications, particularly low cost commercial or portable device embodiments, the burden of raw data storage and management presented by such a large data set may be prohibitive.

Although constant δt sampling may be desirable and necessary for certain analytical transform methods, a valuable aspect of the present invention is the use of novel non-linear sampling schedules whereby δt is progressively increased for each successive sample acquired during each half cycle. By convention, fast processes are those that run to completion within the first few tens of milliseconds of each half-cycle. To capture the details characterizing these early, rapidly evolving events, fast sampling is surely necessary.

Conversely, there are other slower processes having responses that evolve over a time scale of many seconds. These are manifest in the tail section of the response waveform with its much gentler slope and commensurately diminished high frequency content, thus allowing a substantially relaxed sampling schedule to be employed without sacrificing any measurement accuracy.

Therefore, when the actual time domain response of the evolving polarization voltage is of interest, a non-linear sampling schedule can be prescribed whereby the inter-sample time is progressively increased in a particular fashion throughout each half-cycle. Excellent resolution is achieved for both the early/fast and later/slower polarization processes, with a total accumulation of far fewer actual data points as compared to the conventional constant δt sampling paradigm.

One preferred non-linear sampling sequence is based on a geometrically increasing series of inter-sample delay times δtᵢ, each of which represents an integral number of base clock periods, ΔT_{CLK}, which base clock is derived from a separate fixed frequency oscillator, preferably operating at one megahertz or higher. One useful algorithm for generating an appropriate series of sample events is based on an exponential relationship, wherein δtᵢ represents the time delay between the abrupt step corresponding to the beginning of a half-cycle and the i th designated sampling point:

δtᵢ=[ΔT_{CLK}]×[K^{(α)}]. K=constant, a is a member of a set of values

To create the simplest type of sampling schedule whereby N geometrically spaced samples will be acquired during each half-cycle, a set of ascending values for a is provided, {αᵢ} for i=0 to N, where i represents the index of a sample delay value, for example αᵢ={0, 1, 2, 3, . . . , N}, and N is made equal to 2.

When the formula is applied to this set, the sampling sequence will appear as a simple exponential series of N+1 time delays, each of which is an integral multiple of the base clock period ΔT_{CLK}. Moreover, the ratio between any adjacent pair of time delay values is be precisely 2, so that the entire set of time delays corresponds to a geometric series; if the base clock is set to 1000 Hz, then ΔT_{CLK}=1 millisecond, yielding series {1 ms (delay of first sample from step), 2 ms, 4 ms, 8 ms . . . }. In some cases, it is useful to establish a sampling schedule with finer granularity by allowing K to assume a value that corresponds to a fractional power of 2, like 2½ and so on. Since, in this case, the resultant series produced by the formula will no longer comprise only whole numbers (the square root of 2 has an infinitely repeating fractional component), a rounding method must be used, whereby the αᵢ values are rounded off to the nest higher (or lower) integer, since by assumption, it is not allowed to specify a sampling schedule that contains δtᵢ values that are not integer multiples of the base clock.

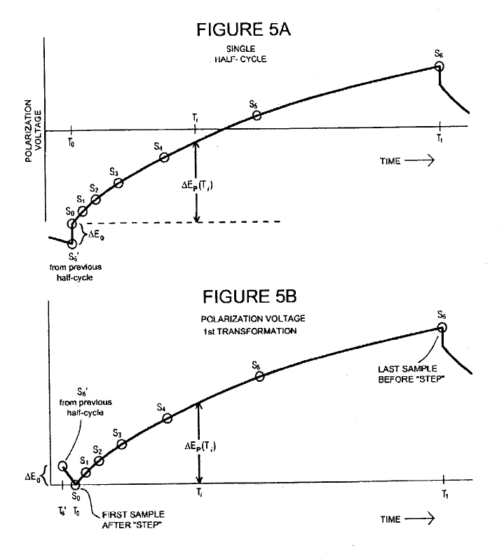

Moreover, in some cases, it may be preferred adjust the scheduled time delays for, or completely omit, the first few samples in each series, particularly to avoid the peak caused by the inductive behavior of the DUT or the test fixture. By appropriate selection of the parameters, a series can be constructed which provides many closely spaced samples during the early part of the polarization waveform where fast events occur, with fewer samples later on as the rate of change of the polarization voltage is diminishing. By resetting i to zero at each stepwise transition and then incrementing again to N, an identical sampling schedule is generated for each half-period, greatly simplifying later analysis. FIG. 5A shows a typical polarization waveform, with seven sampled data points in each half-cycle, representing an exponential sampling schedule [Sᵢ, i {0 to 6}].

1. First Transformation Step: Graphic Normalization & Averaging

Once the sampled data is collected, a normalization transformation may be performed, whereby the time varying portion of the response is separated from the stepwise abrupt transition that defines the beginning of the half-cycle. This transformation may be applied to either uniformly or non-linearly sampled data. Referring to FIG. 5, the polarization voltage value of sample S₀ (at time T₀), being the first sample following the transition, is used as a reference value, and is normalized by convention to a value of zero, as shown in FIG. 5B. The actual voltage difference between sample S₀ and S₁ is then calculated from the raw data and used as the y-value for S₁ in FIG. 5B; successive samples are treated similarly, leading to an upward tending curve that intersects the x-axis at time T₀. The magnitude of the difference, designated ΔE₀, between sample S₀ and the final sample from the preceding half-cycle represents the size of the step. In FIG. 5B, the magnitude E of the step is plotted immediately to the left of sample point S₀, at time T₆. In the graph, a line is shown connecting points S₆ and S₀. In fact, the transition of the polarization voltage between these points is very rapid, and so that point S₆, if plotted according to the time scale used for all the other sample points, would appear almost directly above point S₀. To facilitate interpretation of the graphic data in FIG. 5B, point S₆ has been shifted slightly to the left and a connecting line drawn to point S₀.

This transformation is applied individually to the data from each half-cycle, resulting in a set of vectors each containing N+2 elements (that is, samples S₀ to S_{N}, plus the □E₀ value). To ensure that the data contains no artifacts, the information from the first two half-cycles (one complete square wave cycle) may be omitted from subsequent analyses. The remaining M vectors are then divided into two groups (corresponding to positive and negative half-cycles, according to the sign of the excitation current) as shown in FIG. 3A. Each of these groups can be formally described as a two-dimensional matrix, comprised of M vectors, corresponding to the number of whole cycles used in the analysis, containing N+2 elements. Within each matrix, the values of corresponding elements are added together and these sums are each divided by the number of vectors in the matrix, yielding a single N+2 element vector representing the mean value of all the vectors in the matrix; these are designated as the mean positive vector and the mean negative vector.

As is well known to practitioners of the art, such an averaging technique when applied across M cycles of a periodic waveform serves to reduce the effect of any random noise signals present within the raw waveform data, by approximately a factor of M^{1/2}; furthermore, the effective bandwidth of the signal is not limited.

Provided that the DUT is in an open-circuit state, and the internal chemical reactions behave reversibly for the small excitation signals employed (and do not exhibit any hysteresis effects), the shapes of the mean positive and mean negative vectors will be mirror images, reflected across the x-axis (time axis), specifically, when all the sample values in the mean negative vector are multiplied by minus one (hence, are normalized by sign inversion), the resultant inverted negative mean vector should perfectly match the mean positive vector. Any difference between these two sign-normalized vectors indicates either that state of the electrochemical system within the DUT has changed during the data acquisition period, or that the DUT was behaving in a nonlinear fashion as a result of the excitation itself. Provided that these mean vectors are congruent, they may be averaged, yielding a single vector characteristic of the device under test. A graphic presentation of these vectors is immediately useful for qualitative understanding of the device's performance and condition.

2. Second/Third Transformation Step: Linear to Log Time Axis

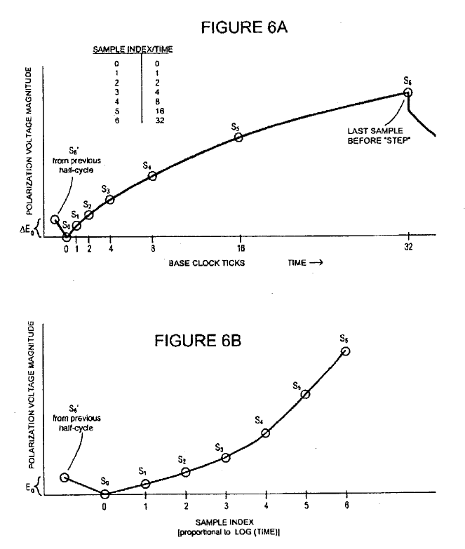

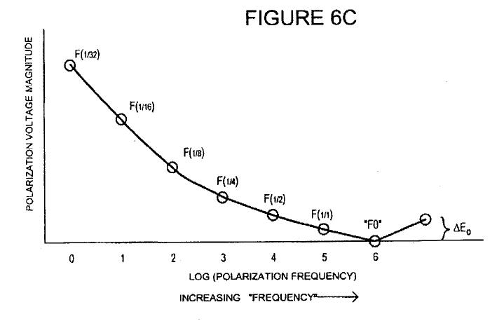

In the preferred embodiment, to further aid comprehension and understanding of the mean vector data, two additional transformations are undertaken. These require either that the data has been sampled according to an exponentially derived schedule, or that evenly sampled data has been re-sampled (or decimated) according to a similar exponential rule. In FIG. 6A, a typical positive-going mean vector is shown as a continuous curve, with the actual sampled data points indicated. The accompanying legend provides the correspondence between each sample point (either identified by an integer index or as ΔE₀) and its relative time of acquisition, in base clock periods, relative to the step-wise transition. The index values increment uniformly, while the time values increase exponentially.

When the data is replotted using the integer index values as the x coordinate, FIG. 6B results, now exhibiting a well-known logarithmic characteristic, due to the fact that the index of each point is directly proportional to the logarithm of its associated time value, δt₁. Note that each point in linear space finds correspondence with a unique point in logarithmic space. This transformation facilitates immediate visual identification of curvature changes, which signal the occurrence of underlying processes. Details of fast processes are sufficiently spread out to be readily apparent, while the portion of the graph allotted to slower processes is relatively compressed without loss of any important information.

A further manipulation of the logarithmically transformed data is performed, by simply reflecting the curve about the vertical axis, as shown in FIG. 6C, and translating it horizontally so that the data point S₀, corresponding to the last element in the mean vector, becomes the y-intercept. These points are re-labeled in the graph, for reasons, which now become apparent.

In the preferred embodiment, the information of interest relates to the change of polarization voltage as it evolves during each half-cycle of the excitation current. Each sampled data point is uniquely identified by an offset interval δtᵢ, measured with respect to the previous transition. It is useful to define a new quantity, the equivalent polarization frequency f_{Pi} corresponding to a specific sample point i, referred to hereinafter as the polarization frequency, which is equal to 1/(2×δtᵢ), where this value represents the fundamental frequency of the symmetric square wave comprising the two half-cycles each of duration δtᵢ.

In this manner, the point associated with the lowest measured polarization frequency (that is, having the longest sampling delay interval with respect to its corresponding step transition) appears leftmost on the graph, with ascending frequencies proceed to the right. The graph is again logarithmically scaled with respect to polarization frequency, such that while the ratio of adjacent frequencies is constant, succeeding points are uniformly spaced along the x-axis. This manner of presentation, plotting polarization frequency along the abscissa, has been found to be more convenient and more easily understood by those familiar with the art. Viewing polarization response in terms of frequency allows immediate comparison to the vast amount of Frequency Response data available in the “Impedance Spectroscopy” literature.

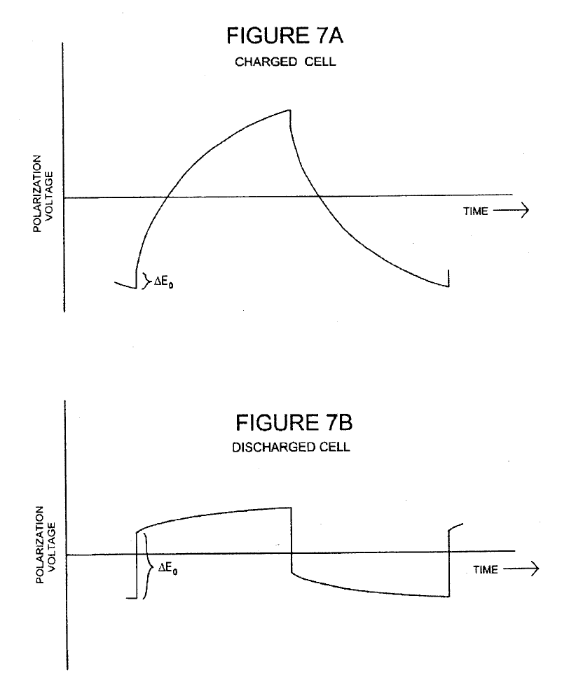

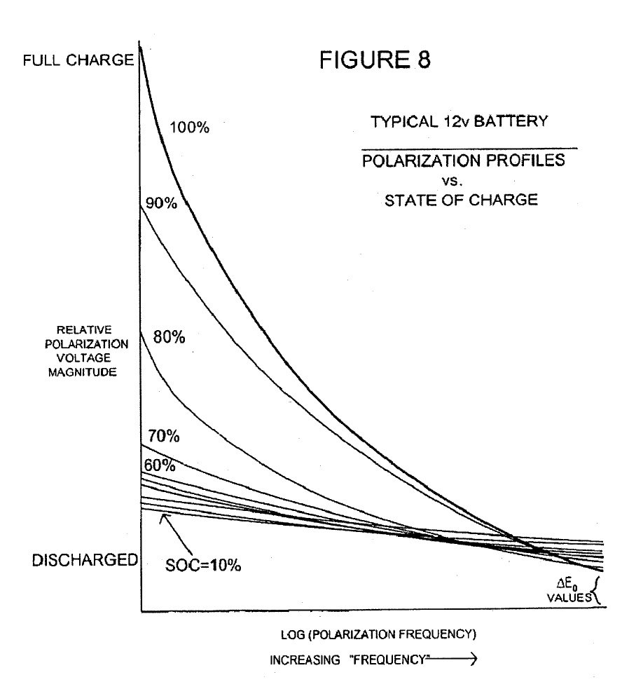

The present invention supports qualitative and quantitative analysis of energy cells. FIG. 7A provides a typical polarization response of a fully charged lead-acid cell. The peak-to-peak magnitude of the response across the cell is preferably not greater than several millivolts, to preserve linear response. FIG. 7B is the response of the same cell, in a discharged condition. Intermediate states of charge exhibit curves falling between these two extremes. At progressively higher charge states, the magnitude of ΔE₀ decreases monotonically, while the steepness, and hence the overall height of the waveform, increases. The twelve curves presented in FIG. 8 represent data from a single 12 volt lead-acid automotive battery at different states of charge. The bold line represents the mean values of the sample population at full charge, while the others depict the response of the battery discharged and at ten ascending states of charge. This sequence reflects the changes produced by ten one hour charge events, each at the C/10 rate. For a fully charged battery, the curve appears steeply curved, with the polarization voltage increasing as the polarization frequency decreases. In the discharged state, the curve is nearly horizontal, exhibiting at the high frequency (right) end, a value approximately twice that of the charged unit. Intermediate charge values fall between these two curves.

Method Variant #3

As described previously, the DC offsetting signal may be adjusted to accommodate slow variations in the intrinsic bias voltage presented by a DUT whose relative state of charge is changing as a consequence of receiving either a charging or discharging current concurrently with the time-varying current excitation as prescribed by the inventive method. According to well-known principles of circuit theory, separate currents may be summed at a circuit node, which node in this example corresponds to that terminal of the DUT connected to the current driver. During a simultaneous application of both a test current signal and a charging or discharging current signal to said DUT terminal, it is therefore contemplated that the time-varying polarization response component attributable to the test current can be isolated and analyzed, to provide real-time information regarding the state of charge and condition of the DUT.

When a DUT is connected to an operating external charger or discharger, the test method may therefore be applied in situ while the DUT is being charged or discharged, respectively. In light of the fact that the excitation of the inventive device may comprise arbitrary waveforms, the device can be adjusted to perform both as a tester and a charger/discharger simply by modifying the excitation current so that it exhibits a suitable DC or slowly varying offset current, which offset current represents the desired charge or discharge current value.

Due to the fact that preferred test waveforms exhibit abrupt discontinuities and may be configured to appear as series of rectangular pulses (whose characteristics may be adjusted as needed), the test device may be effectively transformed into a pulse-mode charger (or discharger) by using an excitation that exhibits a net positive or negative bias and also contains a time-varying component suitably disposed for eliciting a time-varying polarization response that may be synchronously sampled to yield samples that are analyzed to provide an evaluation of at least one characteristic of said system.

Moreover, the diagnostic information obtained according to the method may be used to modulate the charging/discharging process to further improve its performance. Specifically, the sampled values (or the results of their analysis) may be used in a closed-loop topology (e.g., a feedback system), whereby modulation is effected for certain excitation characteristics including the net bias of the excitation (i.e., its average value), and the amplitude, duration or duty-cycle characteristics of the time varying waveform component of the excitation. By incorporating these variation into the inventive apparatus, it may be used in applications where the well-known the benefits of pulse-mode charging, such as reduced charging time, improved charging efficiency and remediation of a variety of cell deterioration mechanisms (e.g., sulfation in lead-acid cells), are desired. An example of such an improvement is now provided.

Predictable real-time variations in the peak-to-peak amplitude of the polarization response can be used to detect the end of charge condition in a lead-acid battery. A constant frequency square wave excitation (at 0.1 Hz) is preferred, and the response is continuously monitored throughout the charging process. Under dynamic conditions (charging or discharging), the offsetting voltage is continually adjusted to compensate for the changing potential of the device under test. As the battery approaches its fully charged state, the amplitude envelope (peak-to-peak value of polarization response) exhibits a rapidly increasing magnitude, indicating an increase in the Faradaic resistance followed by the onset of the oxygen evolution reaction as the polarization voltage reaches the gassing point. The response curve of a healthy cell will appear smoothly curved, with a steeply sloped onset, gradually tapering off to an asymptotic response (whose maximum amplitude is proportional to charging current). In contrast, an unhealthy cell that has a reduced level of absorbed electrolyte, due for example to previous episodes of overcharging, shows a pronounced kneel in the curve: the rate of change of the polarization response (its slope) abruptly assumes a lower value.

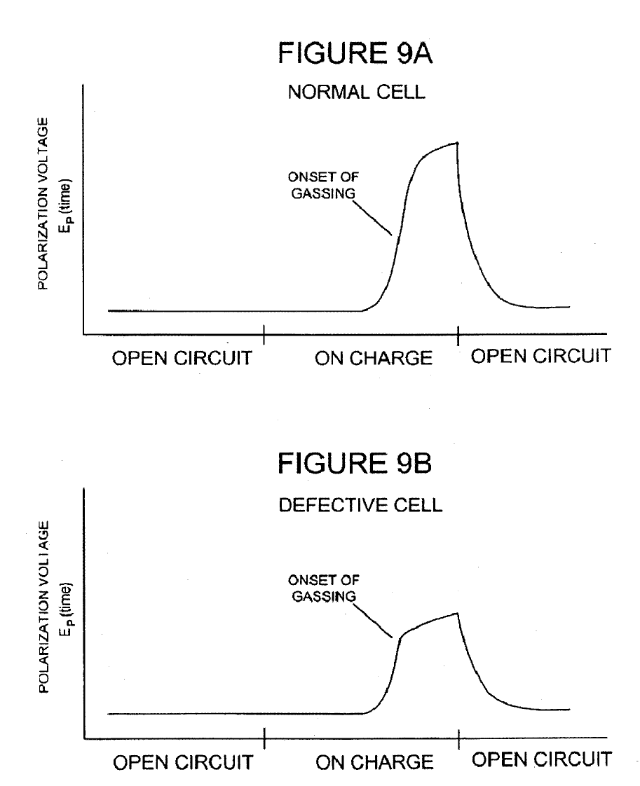

Two important factors are evident here, shown in FIGS. 9A and 9B. First, when the polarization response begins its precipitous rise, the cell has accepted all the energy it can for recharging so the energy is now going into electrolysis. At this point, it is preferable to discontinue charging, since further energy input is no longer increasing the state-of-charge, but is merely generating gas and unnecessary heat. Second, the knee in the curve is indicative of a relative increase in the electrochemical depolarization process occurring at the negative plate, due to the increase availability of gaseous oxygen, which has escaped from the electrolyte and is diffusing directly to the negative plate. Thus, the presence of such a knee is symptomatic of cell dry out, that is, a depletion of electrolyte, as is often caused by excessive overcharge.

Method Variant #4

While most of the preferred excitation protocols comprise waveforms that exhibit abrupt discontinuities, there are occasions where the use of curvilinear waveforms, such as sine waves, is desirable; the use of sinusoidal excitation is encompassed according to the inventive method. While sine waves do not contain any abrupt transitions that may be used to define a ‘beginning’ of each waveform, they do exhibit a particular symmetry wherein each cycle contains two evenly spaced zero-crossings, or alternatively, two evenly spaced amplitude maxima of opposing polarity. Either of these pairs of points (e.g., zero-crossing or peaks) may be conveniently defined as the ‘beginnings’ of the excitation waveform part-cycles, which beginning points may be used for the purpose of establishing sampling synchronization. Note that in general, any convenient (and corresponding) points within the two consecutive half-cycles of a sine way could be defined as the ‘beginning’ points.

The use of synchronous sampling permits the point-by-point data averaging techniques previously described to be employed, to achieve the known benefits of noise reduction without causing any change in the frequency spectrum of the sampled data (other noise reduction methods such a Finite Impulse Response (FIR) filtering inevitably lead to a reduction in the bandwidth and phase shift of the filtered signal).

In some cases, however, a reduction in the bandwidth of the filtered signal may be precisely the desired result. A well-known example is afforded by the method of synchronous demodulation, whereby a periodic signal of interests is convolved with (e.g., “multiplied by) a reference clock signal, to yield a synchronously rectified output of the signal of interest. If this rectified output is averaged (or integrated) the resultant (nominally) DC output signal is proportional to the cosine of the angle between the reference clock and the signal of interest, since by assumption, the signal of interest is a response signal produced in a DUT by an excitation, and hence both have the same fundamental frequency.

According to the present method, the response signal of the DUT is synchronously sampled, and therefore the digital data may be manipulated to yield an outcome that is formally equivalent to that produced by a conventional (i.e., analog circuit implementation) synchronous demodulator. A corollary, obvious to one skilled in the art, is that by performing both in-phase and quadrature detection (that is, IQ demodulation) in the digital domain, representative values for both the cosine and sine components, respectively, of the signal of interest may be calculated. The excitation represents a known current, and the response appears as a voltage, so these components represent the real and imaginary parts of the DUT's complex admittance, from which impedance values may be derived. According to well-established techniques, these admittance/impedance values may be assigned to elements of a well-formed equivalent circuit model.

Method Variant #5

A particularly useful class of excitations represent composite waveforms comprising the equivalent of a plurality of sine wave frequencies; such waveforms may be created within the waveform generator component of the apparatus, and therefore the relative amplitude and phase relationships among these various sinusoidal components of the excitation are known a priori. Provided that the response of the DUT is acquired according to the preferred synchronous sampling method, it is immediately possible, via suitable well-established analysis methods (e.g., the Fourier transform) to decompose the response into a plurality of vector components, each of which constitutes the amplitude and phase values of a particular frequency component. By this method, a multi-tone test scheme may be directly implemented within the context of the inventive device. Furthermore, conventional harmonic distortion and intermodulation distortion analyses may be performed on the sampled data (that is, through the identification of any frequency components in the response signal that were not present in the excitation) to aid in the characterization of the performance of the DUT, and thereby accurately determine the nature of non-linear behaviors that can be correlated with, and hence will be descriptive of, underlying electrical and electrochemical processes.

Method Variant #6

Another alternative embodiment relates to evaluating primary (single-use) electrochemical cells. Here again, complex pulse-type current excitation signals are applied to the cell and concomitant time-varying cell polarization voltage data is acquired. The shape (i.e., the magnitude and curvature) of the curves obtained when the polarization voltage response is plotted as a function of time provides information about the state or characteristics of the cell. To assess the condition of an unknown cell, its excitation-response profile(s) (time-series data) is obtained and evaluated in comparison with previously obtained benchmark data for the particular cell/battery type, via look-up table, logic, or data processing algorithms. The results of this evaluation can be presented either with results displayed via an illuminated ‘GO/NO-GO’ indicator, or presented quantitatively as percent state-of-charge, or with a specific indication of relative cell health condition or failure mode.

According to one embodiment disclosed above, a non-invasive test may be accomplished by, a symmetric, bipolar square wave current (that is, of alternating positive and negative sign) on an electrochemical cell (or battery of cells), and the resultant time dependant polarization voltage response is measured. To ensure that the condition of the cell is not substantially altered by the test itself, the excitation signal current must be properly adjusted to elicit only a very small peak-to-peak voltage response, typically 0.1% of nominal open-circuit voltage of the cell. Due to the symmetry properties of the excitation (both in the time and amplitude domains) the net energy state of the cell will not be significantly affected by the test. Thus, such a test can be repeated many times with virtually identical results. Since the excitation signal is small by assumption, is periodic, and exhibits a constant peak-to-peak amplitude, the response will also exhibit a constant peak-to-peak amplitude response throughout the entire test protocol duration. The information contained in the response signal represents the actual time domain response of the electrochemical system, and may be manipulated (via suitable mathematical transforms) to yield frequency response information. In addition, values for the elements of an equivalent electronic circuit model can be calculated. Finally, the characteristics of specific electrochemical processes often can be derived directly from graphical analysis of the time domain response plots.

When it is desirable to test certain types of primary cells, it is often preferable to modify the excitation: the symmetric, bipolar waveforms are replaced by unipolar waveforms that contain only discharging and zero-current (rest) events. An illustrative example of such an embodiment is now provided.

Testing the Lithium Sulfur Dioxide Primary Cell

Lithium sulfur dioxide primary cells (LiSO₂) exhibit a 2.95V nominal operating voltage and provide high energy density and a relatively flat discharge profile over a wide temperature range. This combination of low weight per watt and excellent discharge characteristics make them the cell of choice for mission critical applications. The flat cell voltage profile, which makes the cells desirable, also leads to difficulties when it is used as a metric for determining the cell's condition and state of charge.

The LiSO₂ cell employs lithium as the anode and sulfur dioxide as the active cathode material. The electrolyte is typically an organic solvent such as acetonitrile containing lithium bromide to provide ionic conductivity. During discharge, the lithium is oxidized to Li⁺¹ to release an electron to the load circuit. Two lithium ions then migrate toward the cathode area where they combine with two sulfur dioxide molecules, along with a pair of electrons (from the load via the cathode circuit), to form lithium dithionate (Li₂S₂O₄). In cells where lithium is the stoichiometrically limiting electrode, discharge terminates when all of the lithium is consumed. Otherwise, discharge ceases when the cathode becomes blocked by the precipitation of the discharge product.

When the LiSO₂ cell is left in an open circuit condition, the discharge reaction proceeds directly at the anode, forming a thin coating of lithium dithionate that serves as a highly effective passivation layer. This prevents further reaction and self-discharge, leading to exceptional shelf life. After extended storage times the cell's terminal voltage, when first connected to a load, appears somewhat depressed (the ‘voltage delay’ effect). As the discharge current removes the passivation layer, the terminal voltage soon recovers to its expected value. It should be noted that the open circuit voltage of a fully ‘passivated’ cell can rise more than 50 millivolts higher than its nominal value.

A fully charged cell can be expected to exhibit its nominal open circuit terminal voltage of about 2.95V. Upon connection to a load, the terminal voltage first undergoes a rapid drop, followed by a recovery during the next several minutes as it climbs back to a constant value determined by the load current. The value of the ‘recovered’ terminal voltage remains exceptionally constant for a given load current throughout the useful life of the cell. Upon cessation of the load current, the open circuit voltage (OCV) will begin to rise, eventually approaching the nominal value very closely. Thus, OCV is not suitable as an indicator of state of charge.

Synopsis of the Technique

When it is desirable to quantitatively evaluate the state of charge of a LiSO₂ (single use) cell/battery, an extension of the excitation-response method is employed. A pulsed unipolar excitation signal is employed, with the amplitude scaled up to ensure a non-linear “non” non-invasive response. In this case, both the wave shape as well as the amplitude envelope of the resultant polarization voltage response will vary as a function of time, and using these data conjointly allows an accurate determination of the characteristics of cell condition and state of charge.

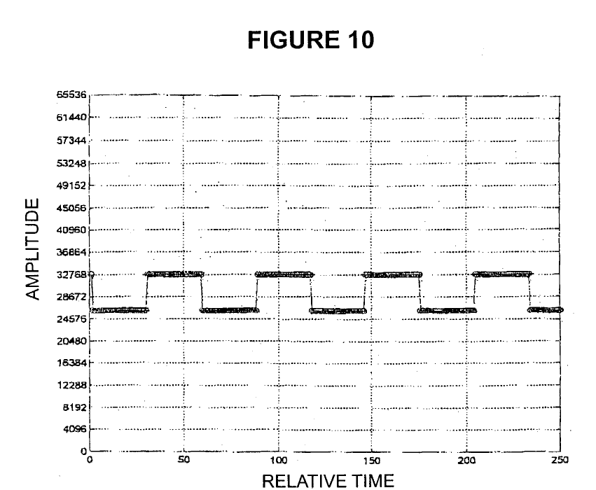

The excitation signal (FIG. 10) is a 50% duty cycle rectangular square wave current, comprised of equal duration periods of constant discharge current and zero current (e.g., open circuit), so that the average amplitude of the excitation waveform is equal to one half of its peak current value. A test protocol commences with alternations between a discharge pulse lasting At seconds, followed by a zero-current rest period of At seconds, and so on, for a number of repetitions, ending with a last rest period of At seconds. The preferred duration of these discharge pulses depends on the particular cell type tested, and must be sufficiently long to ensure polarization of the electrochemical interface. For example, the pulse duration may range from 0.1 to 5 seconds. The amplitude of the current is sufficiently large to produce a slight net discharge of the cell (about 0.1% of its nominal capacity) during a single test event comprising one or more excitation cycles. In practice, suitable current levels fall between C _{1-hr-rate/2} and C _{1-hr-rate/8}, where C ₁₋ₕᵣ₋ᵣₐₜₑ is the nominal amp-hour capacity of the cell.

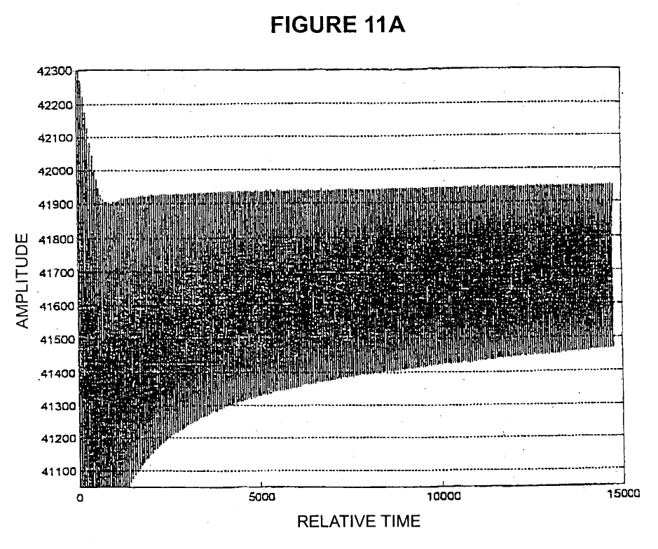

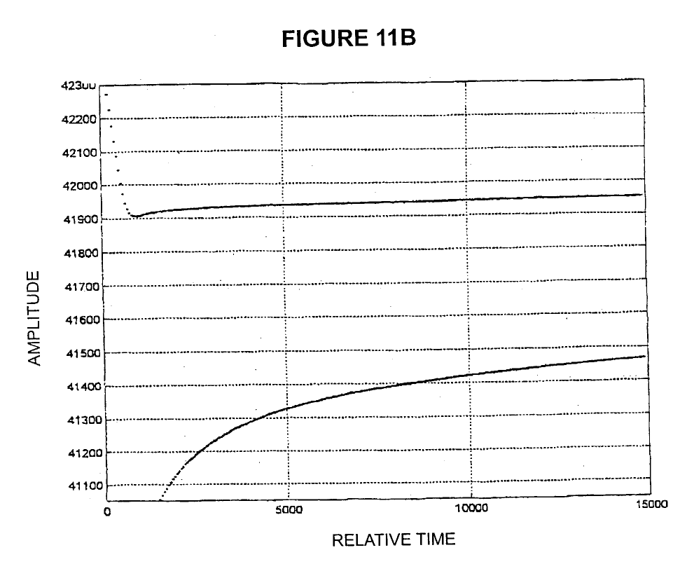

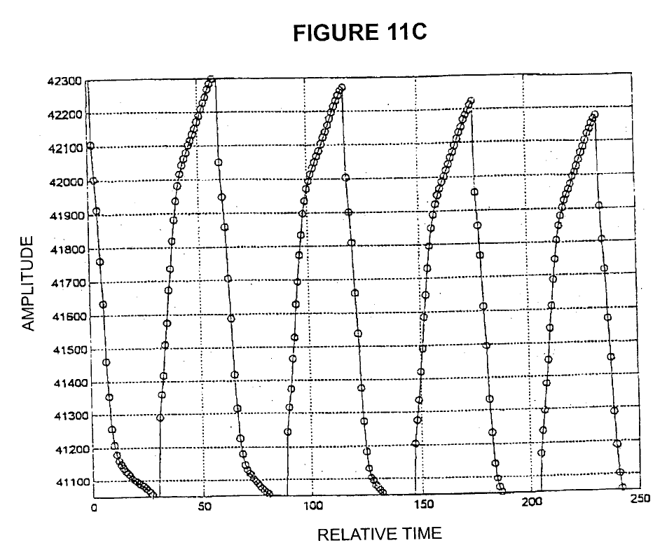

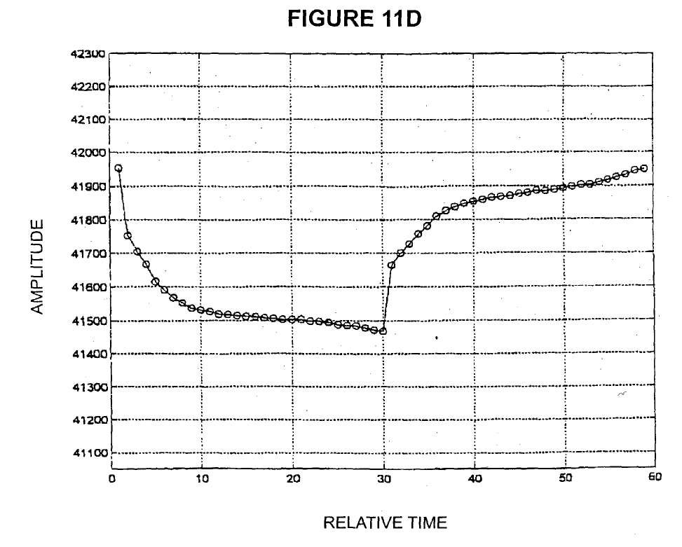

The duration of each pulse is very well controlled (in a prototype test unit, the measured width variation between consecutive one second pulses was less than 2 nanoseconds, equivalent to 1/500 ppm), allowing synchronous data sampling techniques to be used. The cell's voltage during each charge pulse and rest pulse is sampled under an identical sampling schedule. Thus, for all pulses, the N^{th} sample in each pulse is taken precisely k microseconds after the beginning of the pulse. This allows ‘equivalent’ points in consecutive pulses to be directly compared. FIG. 11A provides a plot of the data obtained in a typical test protocol comprising 255 consecutive discharge/rest cycles. Of particular importance are the overall waveform extrema (i.e., the maximum values of positive and negative excursions that occurred during each pulse event), which are readily obtained by this method. When the extrema points alone are plotted in FIG. 11B, the result is the amplitude envelope signature of the cell. Both the overall envelope amplitude (that is, the peak-to-peak cell voltage excursions) as well as the shape of each individual response waveform changes considerably during the course of the test protocol (see FIGS. 11C and 11D). By direct inspection of this type of plot, the relative condition and state of charge of the cell can be estimated. Suitable algorithms, whose rules have been established by analyzing previously obtained baseline cell performance information (or extracted by neural network analysis, through training on full range of ‘charge state’ data from the target cell type), can be employed to automate the measurement/analysis process. In addition, detailed analysis of the raw data provides considerable insight into the behavior of the cell, and allows individual electrochemical processes to be identified and precisely quantified.

Description of a Precision Time Domain Spectrometer Device

The apparatus applies well-controlled current pulses to a Device Under Test. To permit observation of the fast electrochemical events that occur at the onset of a current pulse, the rise time of the current pulse is preferably made significantly shorter than the response time of the fastest process of interest. For example, a pulse rise time on the order of one microsecond may be used for small cells that exhibit low inductance. For larger cells, this criterion may be relaxed by at least an order of magnitude, since the internal inductance of large cells is significant and overwhelms the observable response arising from the very fast initial processes. To avoid errors, particularly when smaller cells are tested, the output, offset current should be no greater than 0.01% of the pulse amplitude. The current driver itself is preferably embodied as a precision voltage controlled current source, operating to ensure pulse shape accuracy in the neighborhood of zero current (and during any zero-crossings). When large cells are to be tested, a simple switched current source (e.g., a bipolar transistor with scaled emitter current-setting resistor) will suffice, where the inevitable errors (pulse overshoot or ringing) at turn-on and turn-off become unimportant.

Pulse amplitude accuracy is ensured through the use of a low skew, programmable waveform generator that incorporates a very stable voltage reference. For precision laboratory applications, this reference should provide a very low noise output, with less than 0.5 ppm/degrees centigrade drift. For less demanding commercial applications, this criterion may be relaxed by at least an order of magnitude. The pulse amplitude is parametrically adjustable, and can be changed to any value for each successive pulse. This feature is useful for cells, which require a substantial depolarizing event (one or several higher amplitude pulses) at the beginning of a test protocol.

Proper pulse generation for precision duration/sequence time is critical for accurate measurement. Nanosecond duty-cycle skew is achieved through the use of high-speed logic and sub-nanosecond, balanced analog switching techniques. Both pulse duration and the composition of the overall excitation sequence are programmable.

To measure the cell's response, a 16-bit high-speed analog-to-digital converter is employed. The sampling schedule may be either constant rate (fixed sampling interval), or parametric-by-pulse. In the latter case, each pulse is sampled according to the same non-linear schedule whereby the intersample time delay increases between successive points: an exponentially increasing series of sample intervals is preferred, but other types of schedules may be employed for specific applications. A useful parametric-by-pulse sampling schedule provides many samples just after the onset of each pulse where fast events tend to occur, and less samples later on as the responses of slow electrochemical processes dominate, which can significantly reduce data processing and storage requirements. For particular applications (e.g., integrated electronic circuit implementations), a very few data points may suffice for effective determination of cell state and condition, allowing inexpensive sampling methods to be used.

To allow batch mode operation, the devise is equipped with an internal microcontroller that supports the user interface (display and parameter input) and provides real time process control including serial communications to an external computer or network.

Description of the New Measurement Technique

When allowed to stand in an open circuit condition, LiSO₂, cells spontaneously develop a layer of lithium dithionate on the surface of the anode. Once formed, this layer provides surface passivation, retarding any further self-discharge. An addition effect of this layer is manifested as an initial ‘voltage delay’ when a load is connected: the cell's terminal voltage undergoes a short ‘dip’ and recovers to its expected value within a short time, as the passivation layer is removed. When a passivated cell is measured by traditional means, its observed electrical characteristics does not accurately reflect its condition and state of charge. Both the apparent impedance of the cell, as well as its open circuit voltage exhibit elevated (and indeed fairly similar) values over a broad range of charge states. Therefore, before any meaningful measurement is possible, the passivation problem must be overcome.

De-passivation is achieved by subjecting the cell to a brief interval of relatively strong discharge current; whereafter measurements yield useful data. In the simplest technique, a constant current discharge event is provided for several tens of seconds, followed by an open-circuit (relaxation) period. By measuring the progressive changes in the cell's terminal voltage during both periods, a reasonably accurate measure of condition and state of charge can be obtained. To achieve effective de-passivation, however, the initial current must be a substantial fraction (about one quarter) of C₁₋ₕᵣ rate, where C represents the nominal capacitor in ampere-hours. While this is satisfactory for new and ‘healthy’ cells, should such a substantial current be applied to a severely depleted cell, it can cause the cell to become totally polarized (zero terminal voltage) and sometimes in fact, reverse biased. Under these conditions, lithium metal can appear at the cathode, leading to the rapid evolution of sulfur dioxide gas (venting), and possibly cell rupture as a result of a rapid exothermic reaction at the cathode.

The present method employs a repetitive series of discharge pulses separated by equal duration ‘rest’ periods wherein the excitation current is zero. A typical test protocol consists of a first 1 ampere discharge pulse lasting 655 milliseconds (equivalent square wave frequency=0.762 Hz), followed by a 655 millisecond rest: this charge/rest pattern may be repeated 255 times. A 16-bit 50 kHz sampler is synchronized with the excitation pulses, so that 65,536 equally spaced samples are acquired during each discharge and rest pulse. The first sample for each pulse occurs 20 microseconds after the edge transition (i.e., at the beginning of discharge current, and beginning of ‘rest’), while the last sample in each pulse is taken at its very end (that is, at its maximum amplitude point). For specific applications, these critical parameters (pulse current amplitude, pulse duration, protocol sequence length) can be adjusted accordingly.

The raw data (here. the sampled terminal voltage of the cell) consists of a series of points that define waveforms whose shape and magnitude undergo substantial, progressive changes throughout the test protocol. The nature and meaning of the data is discussed below.

General Description of the Time Dependent Polarization Voltage

The electrochemical systems of interest (in this case, single-use energy storage cells and batteries) rely on several distinct chemical and physical processes for their operation. The actual electric current produced when a load is connected to a primary cell results from the transfer of electrons between the two reactive electrode constituents during a Faradaic oxidation-reduction reaction. This reaction causes an electric potential to develop between the cell's terminals, which can drive current (the electrons) through an externally connected load. An intact cell is capable of delivering current until at least one of the necessary chemical species (i.e., the electrodes' active constituents) is depleted or otherwise rendered unavailable for chemical reaction. A cell becomes totally discharged when either one of the species is entirely used up, or one of the electrodes has become ‘blocked’ (such as by the precipitation of discharge reaction products). The disclosed method enables the details of these reactions to be detected and recorded, allowing full characterization of a cell's condition and state of charge.

To facilitate immediate comprehension of the information contained in the (potentially) millions of raw data points obtained throughout a test event, it is useful to subject the raw data to a transformation prior to visual inspection and graphic analysis. One preferred transformation consists of decimating the raw data (originally obtained by sampling at a constant, high frequency) according to a re-sampling algorithm, to leave only a series of exponentially spaced points. Since each sequential data point is assigned an identifying integer index as it is acquired, it is simply a matter of selecting among the raw data points according to an exponential series of integers (e.g., 2, 3, 4, 6, 8, 12, 16, 23, 32, 46, 64 . . . ) to achieve the desired decimation. This technique serves to provide high temporal resolution early on in each pulse event when fast processes occur, and reduce data volume later on as slow events predominate.

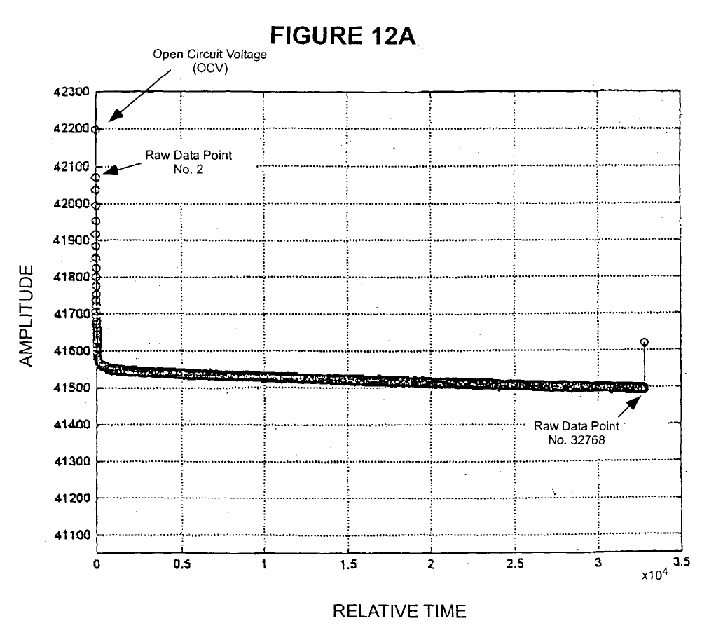

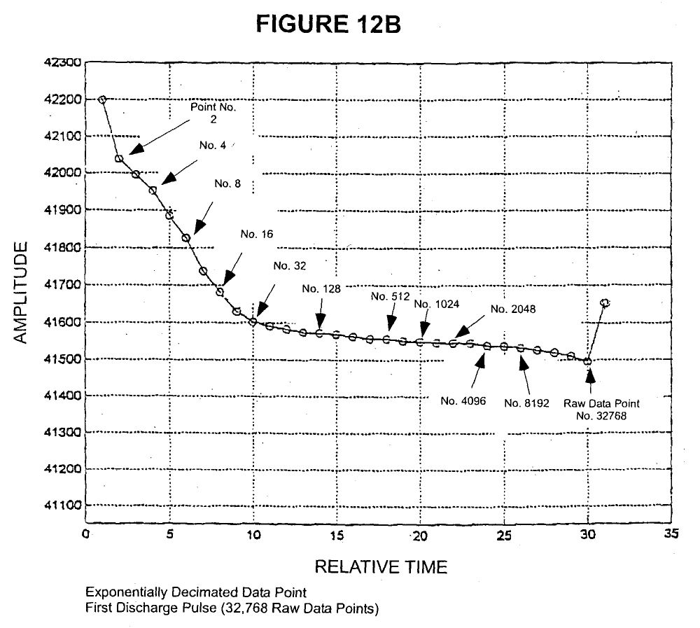

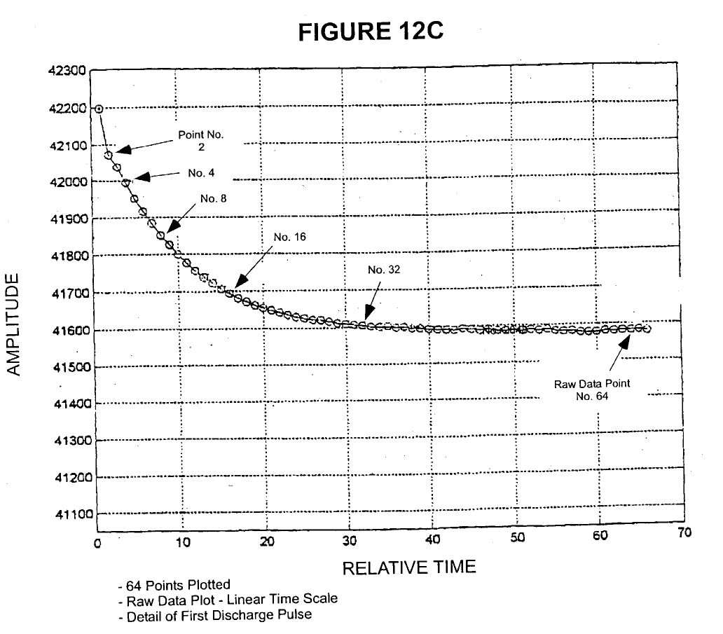

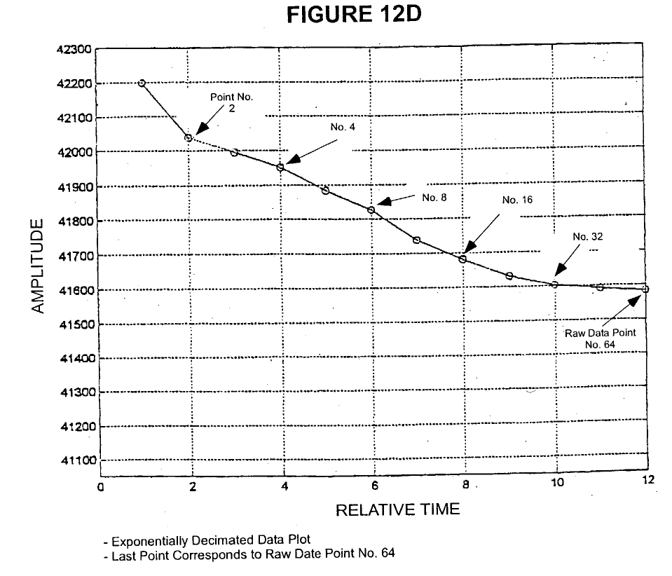

A direct comparison between linear data plots and an exponentially decimated one is provided by FIGS. 12A through 12D. In FIG. 12A the raw data (32,768 points) showing the first discharge pulse appears as a ‘tilted-top’ rectangular pulse with an almost vertical front edge. However, upon examination of the decimated version, FIG. 12B, the linear slope of the first 32 data points (now plotted in semi-log style) indicates an exponentially decaying function. The fine detail of FIGS. 12C and 12D make this completely apparent. By employing the exponential transformation, electrochemical process details may be immediately apprehended from a single graph. Referring again to FIG. 12B, the region between points 32 and 8,192 appears very straight, indicating a second longer process (time constant). Toward the end, a downward curvature is appearing, indicating yet another process coming into play in the cell. Because of the utility of the exponential transformation, most of the plots provided (except actual raw data plots, which are presented on a linear time scale) have been created by this method.

The following paragraphs provide a summary of the several distinct processes that determine the shape of the plot obtained in typical test events. The data from several actual tests (obtained with various test protocols, as specifically noted) have been used. The important characteristic of each distinct region of the plots is the associated time constant, or more particularly, the precise shape of the voltage-time curve, which is indicative of the predominating electrochemical process. The ‘y-axis’ values shown on all the plots are the direct output of a ±10v range, 16-bit data acquisition system connected to measure the full voltage appearing across the terminals of a cell. These 5 digit integers corresponding to values within a 20 volt range, where 65,536 is 10 volts, 00000 is −10 volts, and 32,768 is zero volts. To provide a qualitative calibration reference, FIG. 10 presents a plot of the voltage developed across a 2 Ohm resistor by the rectangular shaped excitation current (0.762 Hz, 50% duty cycle, 1 amp peak).

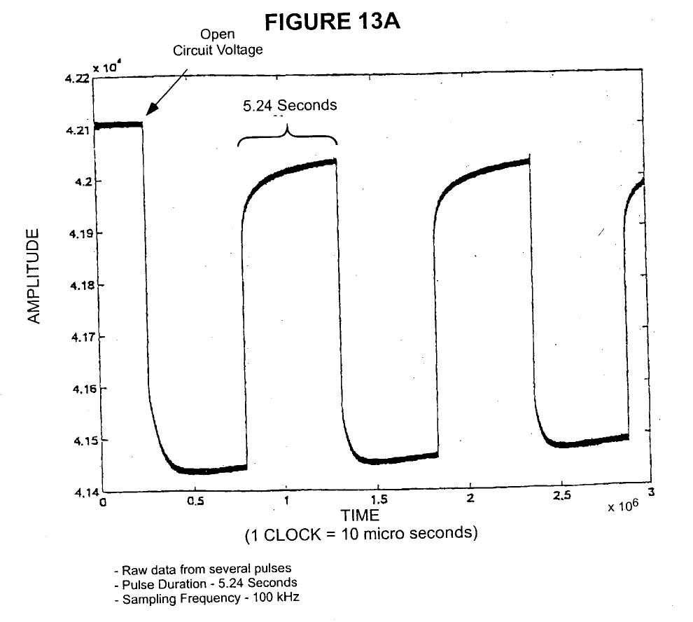

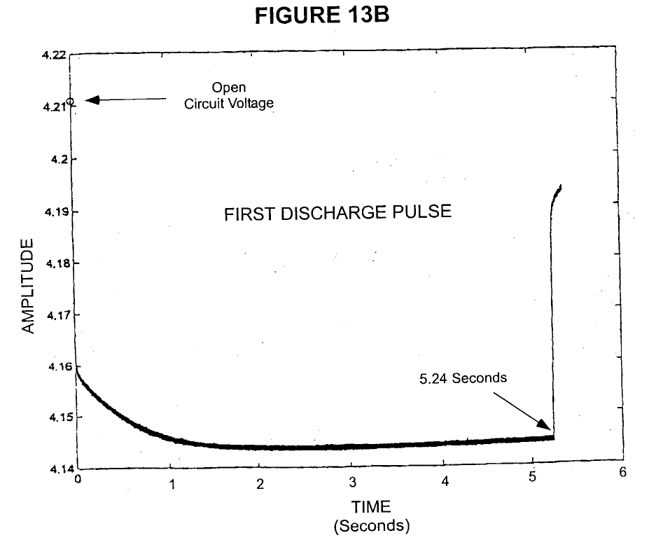

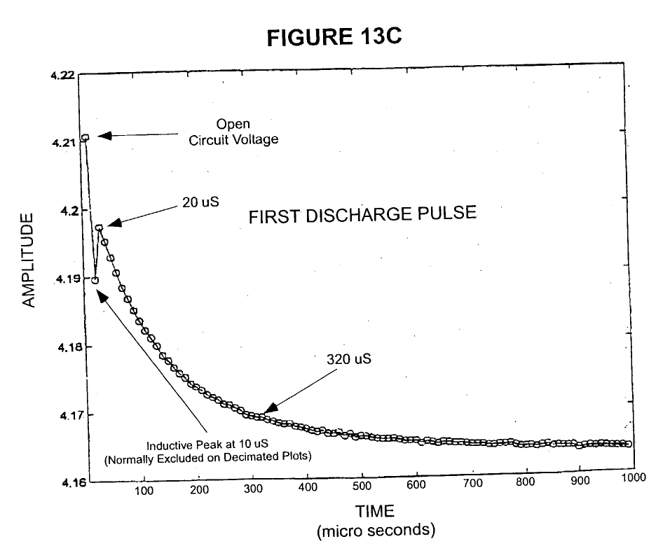

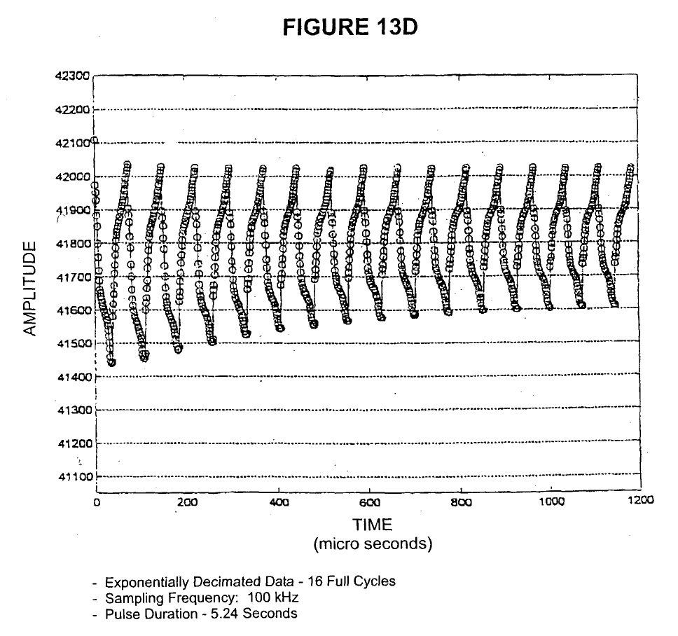

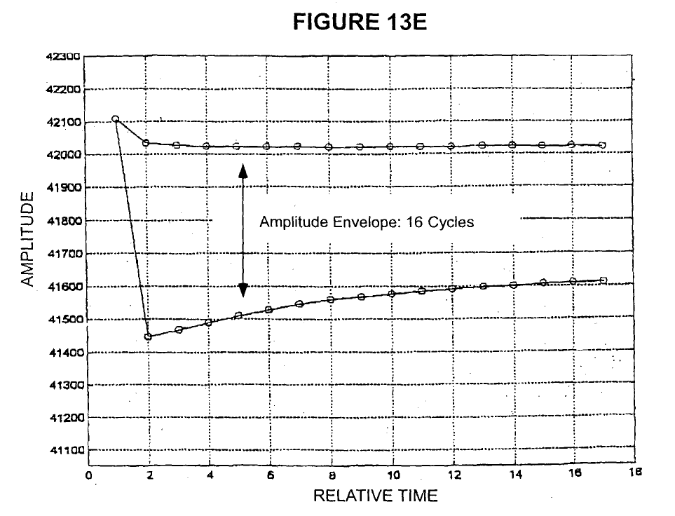

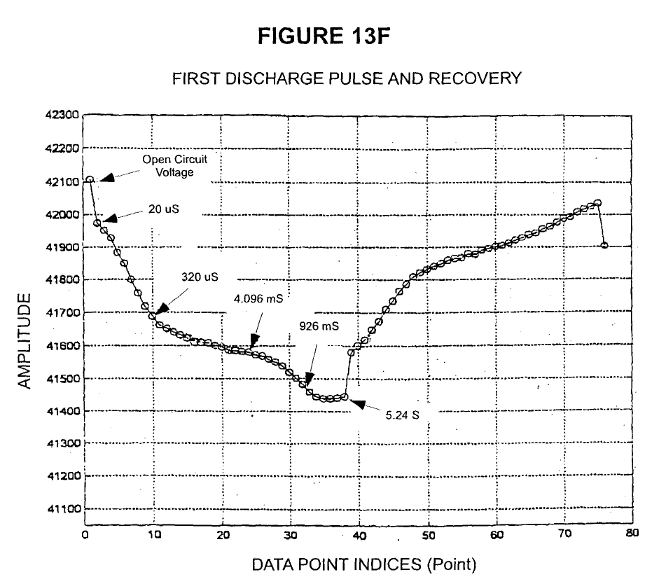

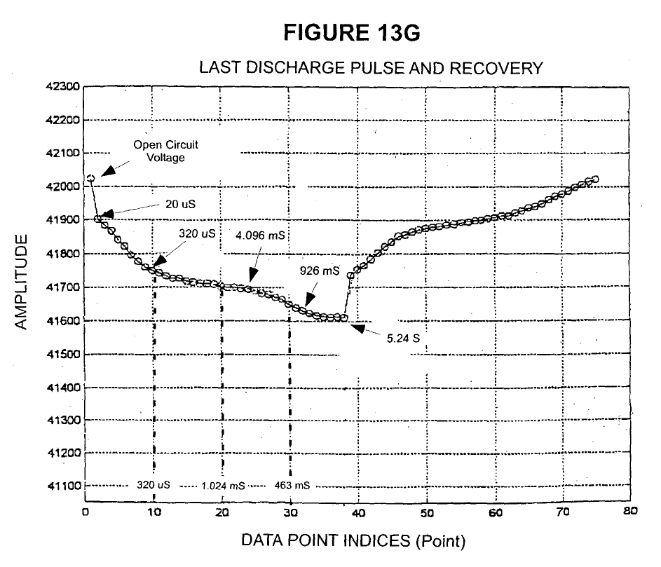

The first data to be considered was obtained from a nearly fully-charged cell that had been left on ‘open circuit’ for more than 12 months. The protocol consisting of 16 discharge/rest cycles (at 5.24 seconds per each charge or rest pulse), with a peak discharging current of 1 ampere. A 100 kHz sampling frequency was used to ensure high resolution of fast processes. FIGS. 13A, 13B and 13C provide plots of the raw data at several levels of detail. Note that this cell had not been subjected to a large de-passivating event (such as a protracted discharge), so there is still evidence of residual passivation in the rounded leading edges of the raw data waveforms. FIG. 13D provides a plot of the entire protocol, after the exponential decimation has been performed; the ‘y’ value of the first plotted point represents the open circuit voltage of the cell prior to the onset of excitation. FIG. 13E provides a view of the cell's amplitude envelope signature which is obtained by extracting and plotting only the highest and lowest points of each waveform (e.g., the envelope extrema values), with the addition of a first reference point representing the open circuit voltage of the cell prior to excitation.

Recall that (other than in raw data plots) all figures present data that has been exponentially decimated with respect to time. Under this transformation, all the points appear evenly spaced along the ‘x’ axis, but the elapsed times between the prior abrupt transition and sample points within each pulse event (e.g., the δtᵢ for each sample) increases by a factor of 1.414 as you move to the right. The net effect is that the plots provide a semi-log representation of the raw data, emphasizing the details of fast reaction processes. Unless otherwise noted, the exponentially decimated sampling sequence begins anew after each step-transition. An example of this exponentially increasing inter-sample time transformation is explicitly shown in FIGS. 13F and 13G, which provide close up details of the initial and final waveforms, respectively, obtained during the test event.

Following the onset of either a discharge or rest pulse, the first important event that is observed is a virtually instantaneous ‘step’ transition in the overall cell voltage (a brief inductive overshoot is apparent in FIG. 13C, and if present, this first ‘outlier’ point is omitted from other plots). Because even the most rapid chemical reactions take some time to occur, such a step-wise transition in cell polarization (that is, an event having a time constant of essentially zero) is attributable to the voltage drop produced by the constant current flowing through the equivalent Ohmic resistance of the cell (i.e., its real impedance component). As such it is linearly proportional to the current's amplitude. On the plots, the ‘step’ appears as a distinct, straight-line segment at the boundary between adjacent pulse events. Three of these ‘steps’ can be seen clearly in FIG. 13F.

Referring to FIG. 13G, the left-most data point shown (point 1) corresponds to the last sample taken from the previous pulse event, followed by the first sample (point 2) of the current pulse event. The ‘y’ distance between these points represents the ‘step’ transition attributable to pure Ohmic resistance effects. The last data sample (point 38) of the negative-going wave was acquired 5.24 seconds after the step transition, while its immediate neighbor to the left (point 37) represents a relative δtᵢ of 3.71 seconds. Since the decimation sequence restarts after the 38^{th} point, the elapsed time to its immediate right neighbor (point 39 on this plot) is only 10 microseconds, and the associated ‘y’ distance between these points represents the next ‘abrupt step’.

The second important region arises from the initial electrochemical events that occur within the neighborhood of the electrode-electrolyte interface, encompassing the surface of the electrode, the actual inter-phase region (double-layer), and outward a short distance into the electrolyte solution itself. Provided that the physical distance between reactive molecules is small (i.e., they are effectively adjacent), reactions proceed at high speeds. The distinct shape of the curve in this region (extending to about 320 microseconds) indicates an underlying exponential process exhibiting an ‘asymptotic approach characteristic’ very similar to a capacitive charging process; this is clearly seen in the raw data of FIG. 13C. While it may appear from the linearly portrayed data of FIG. 13C that this process extends far beyond 320 microseconds, the relatively abrupt change in slope seen in the semi-log FIG. 13F, from about 320 microseconds to 4 milliseconds, indicates instead that this is indeed a distinct region.

The events of the subsequent several milliseconds (320 to 4000 microseconds) are characterized by a somewhat tilted but approximately linear portion on the semi-log plot (points 13 to 23 on FIG. 13F), indicating another ‘asymptotic exponential rata’ region, exhibiting a substantially longer time constant than seen in region 1. At this point in time, the immediately available reactive components within the interface are running out, giving rise to a chemical potential (concentration gradient) which leads to diffusion of more ions from the bulk electrolyte. Due to limitations on the ionic diffusion rate through the electrolyte, this interface region (often known as the extended double layer), begins acquiring a charge that is manifest as an increase in polarization voltage.

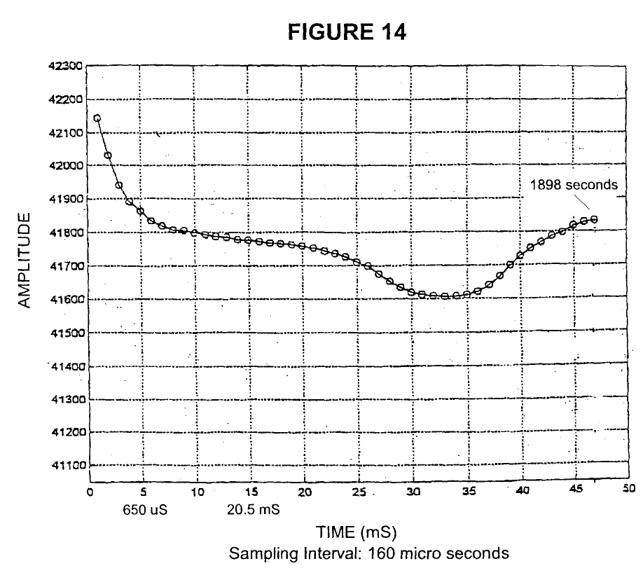

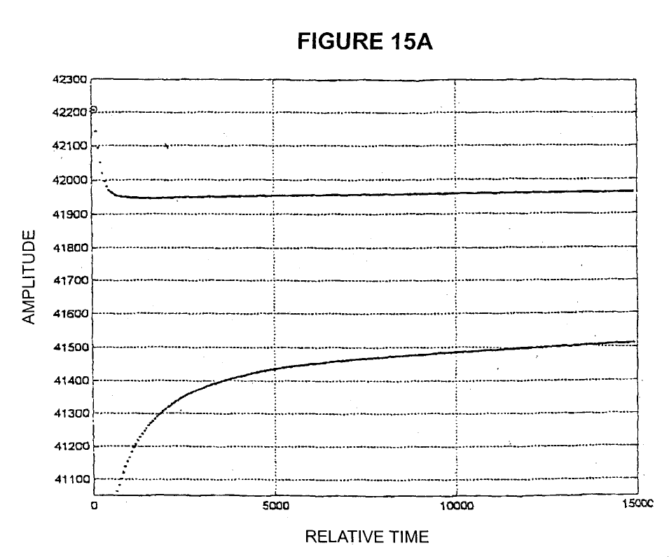

The fourth and final region of interest seen in FIG. 13F begins 4.096 msec after the start of the half-cycle, and includes the region between points 28 to 38. The existence of two distinctly different time constants (each attributable to an underlying process) is apparent. The first potion of the region encompasses less than 1 second, while the second portion of the region covers slightly less than five seconds. Note that the complete behavior of this second process can be seen more clearly in data obtained during a 30 minute discharge test: it is visible in FIG. 14 between points 30 and 35, and appears as a dip’ in the plot. The data of FIG. 14 was obtained with an excitation protocol wherein the discharge and rest portions alternated too rapidly (5.28 sec half-cycle durations) for the response of this final process to fully evolve.

The rising ‘tail’ appearing at the end of FIG. 14 corresponds to the normal voltage recovery effect seen in this type of cell, as it adjusts to the constant discharge current. This final process corresponds to the establishment of a diffusion gradient (a dynamic equilibrium) extending from the proximate electrode surface out into the ionic reservoir of the bulk electrolyte. Within about 20 seconds after the beginning of a long discharge event, the cell's voltage begins its final slow climb from the value during the fourth region identified above, up towards a steady state value (the ‘fifth’ region, not visible in FIG. 14) that is, for a healthy cell, load current dependant. Until the cell is nearing end of life, the value finally attained in the fifth region is relatively flat during the remainder of a discharge event. Since only a 30-minute discharge test protocol is shown in FIG. 14, the fourth region stands out clearly, but only the approach to the fifth region is apparent. In much longer tests performed at a discharge rate of 400 milliamps, this final plateau is only reached after nearly an hour.

Discussion of Individual Test Protocol Data and Analysis Techniques

A brand new 7.5 amp-hour lithium sulfur dioxide cylindrical cell was subjected to a series of equal duration discharge events (400 mA for 2 hours), at 24 hour intervals. The standard test protocol (0.762 Hz, 50% duty cycle, 1 amp peak, for 255 consecutive cycles) was employed, and the cell was tested immediately prior to each discharge event.

FIG. 11A shows the exponentially decimated data (all 255 discharge/rest cycles) from the first test protocol. Since there are 29 data points in each pulse period (here, a pulse period is equivalent to a single half-cycle of the 50% duty cycle excitation waveform), individual points cannot be easily resolved in the plot. Several important features of the cell's behavior are immediately apparent, and are more clearly visible in FIG. 11B, which provides the amplitude envelope extrema signature of the cell. Here the extrema points of the amplitude envelope appear individually, without interconnecting lines. Recall that, while the data points within each pulse event have been re-sampled (decimated) exponentially, the x-axis locations of each abrupt transition appear uniformly spaced along the time axis, such that each complete discharge/rest cycle has the same width (duration) in the plot. Thus, the overall variations and trends seen in successive cycles on the envelope plot reflect their true (that is, linear time-scale) temporal evolution.

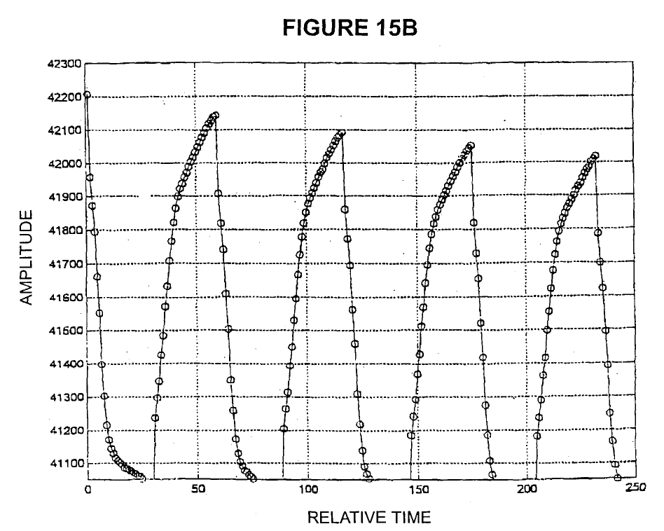

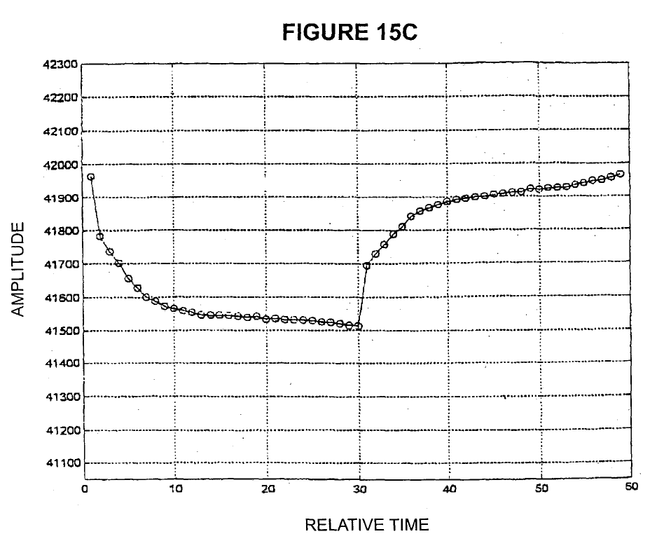

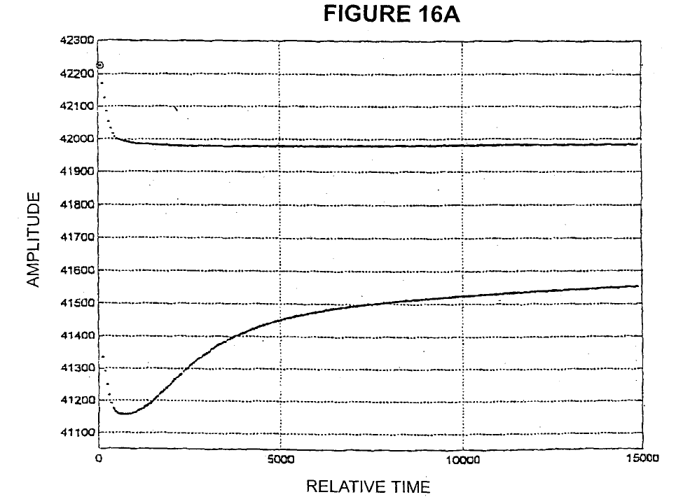

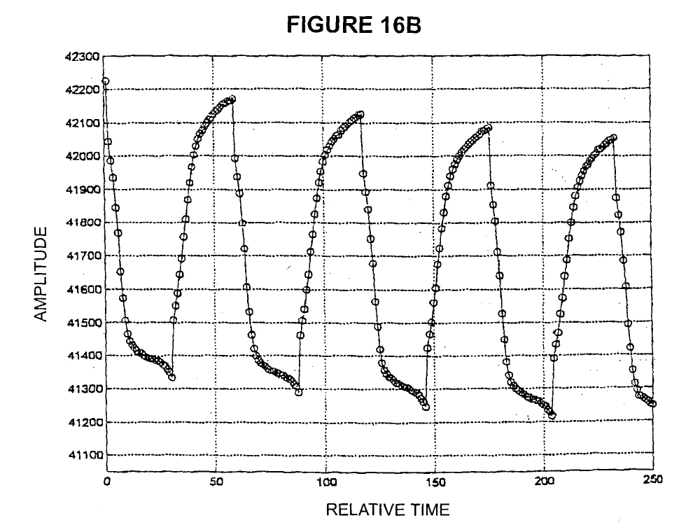

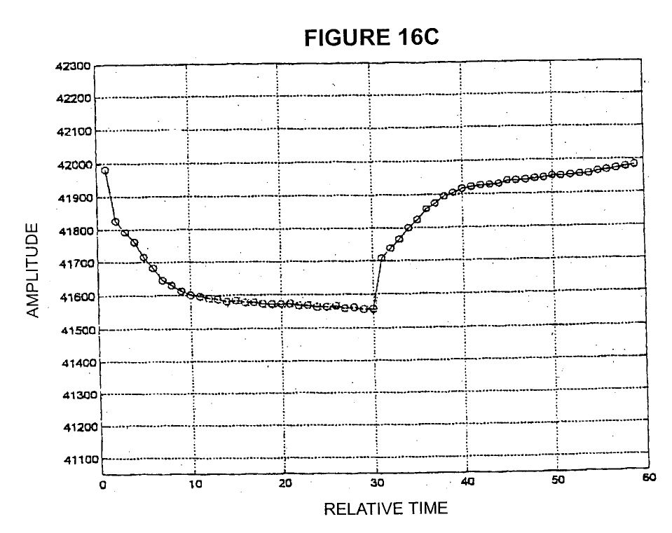

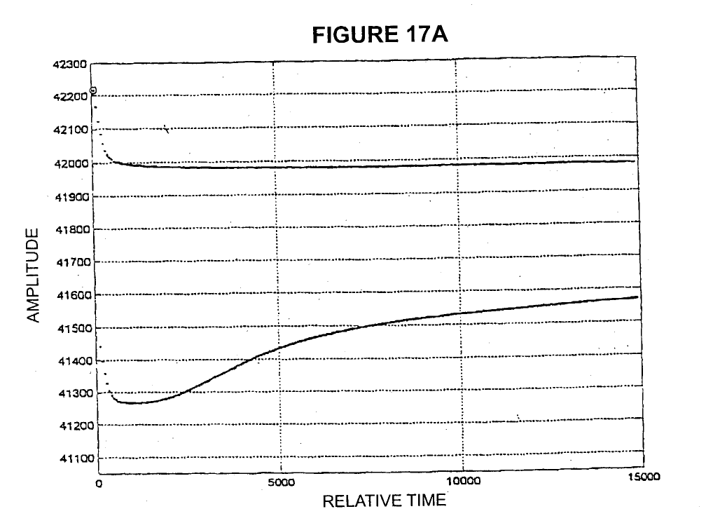

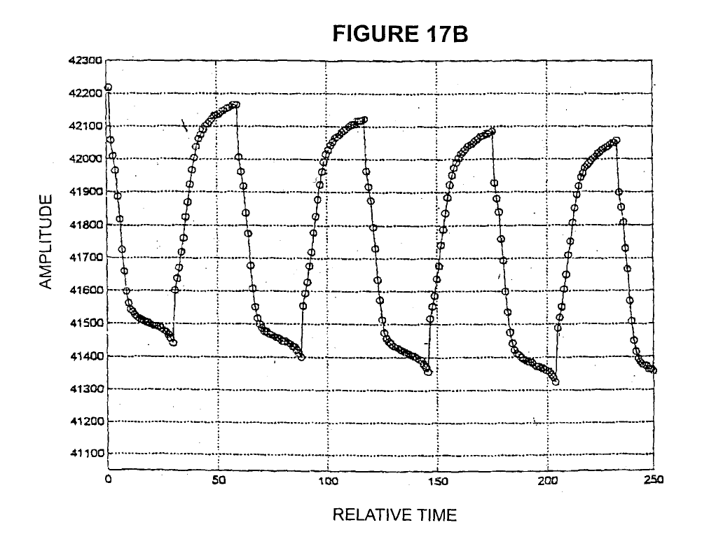

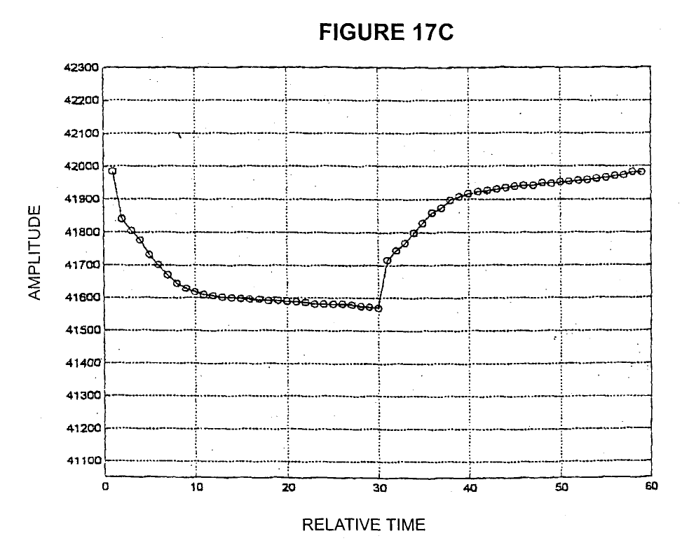

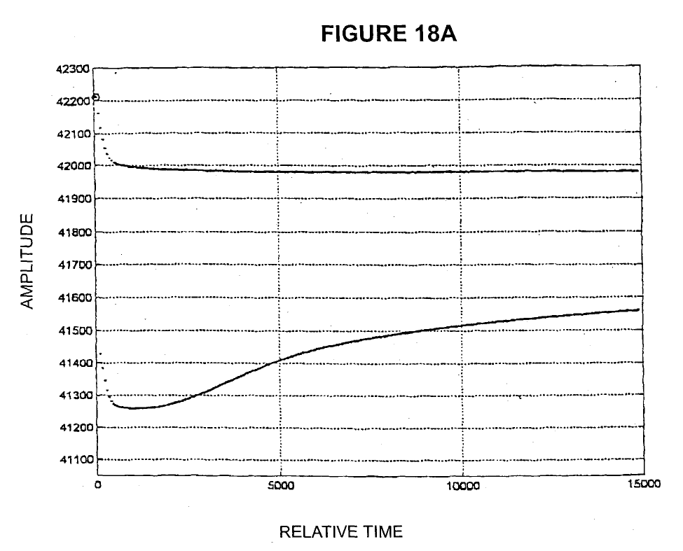

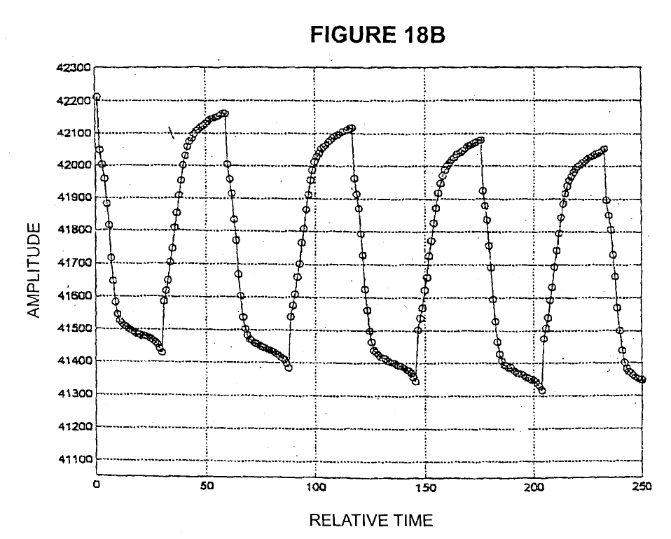

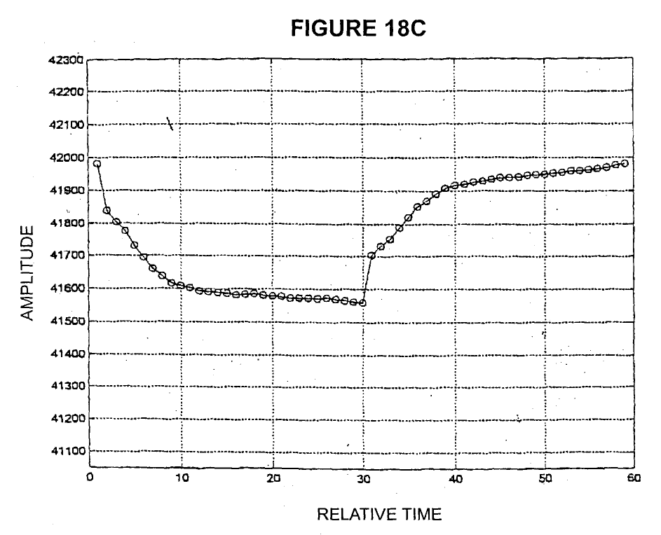

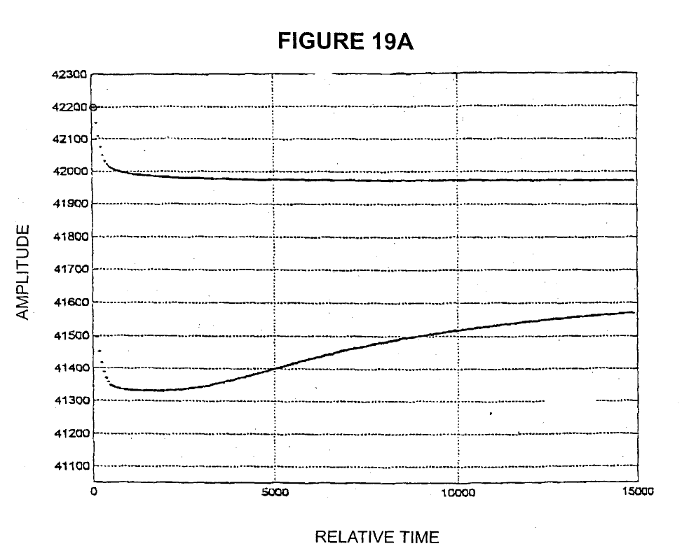

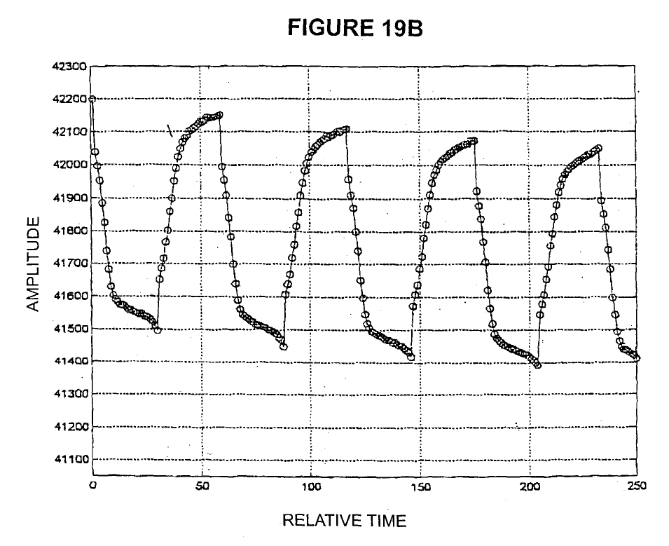

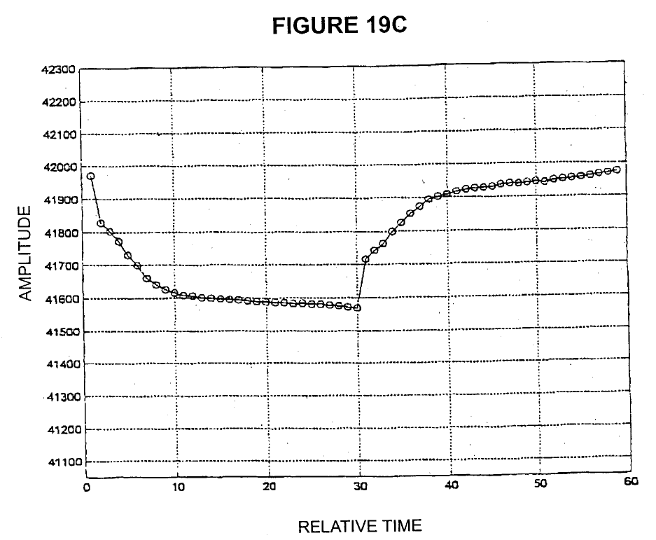

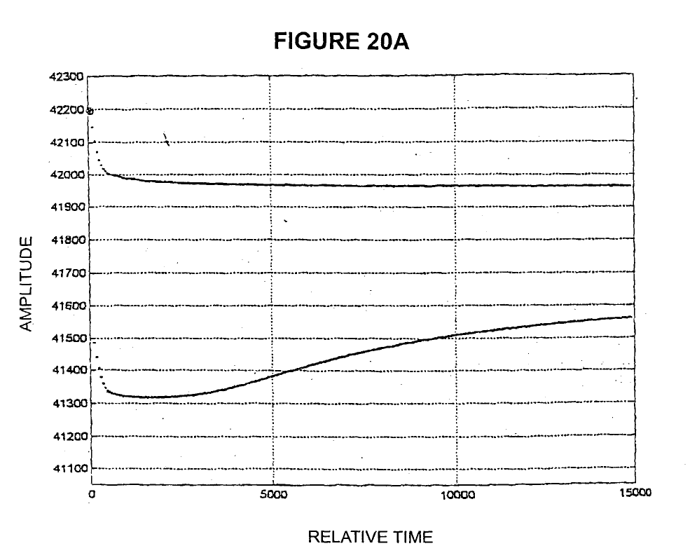

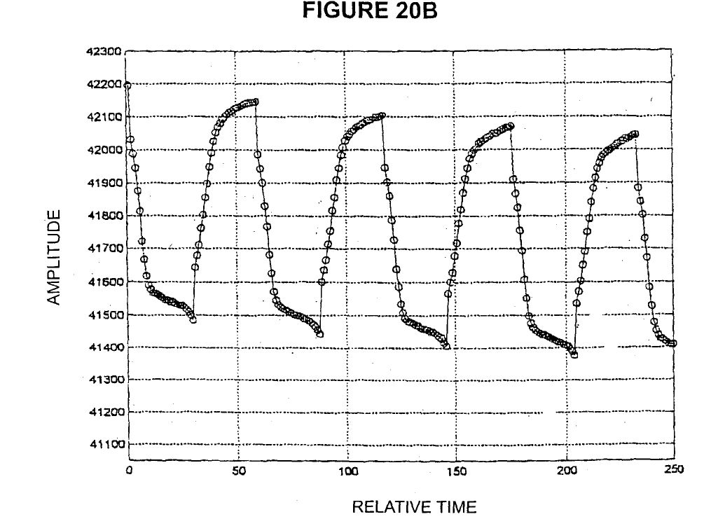

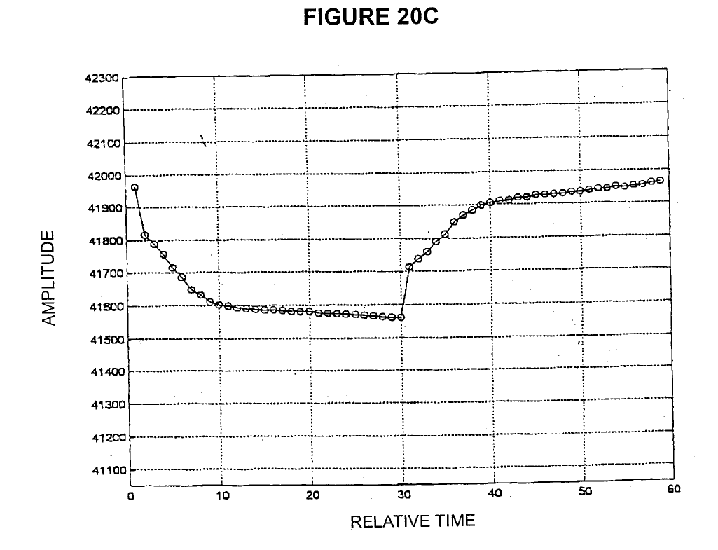

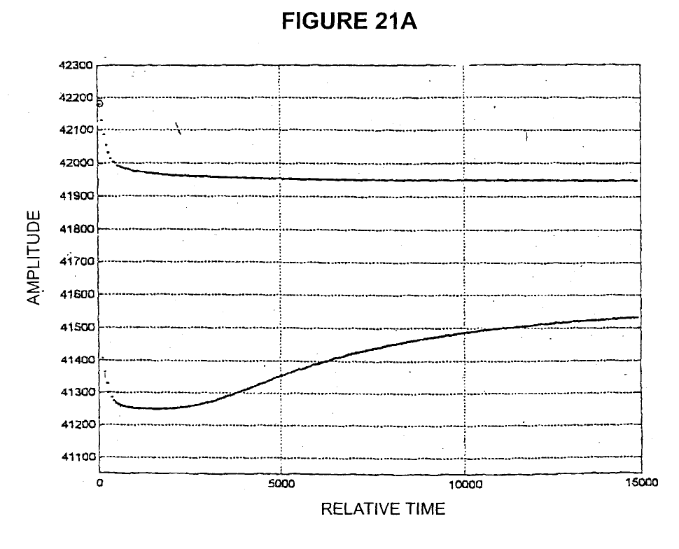

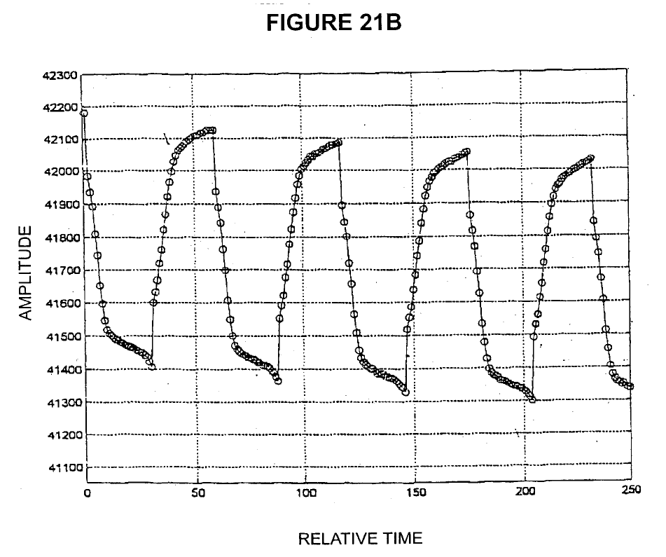

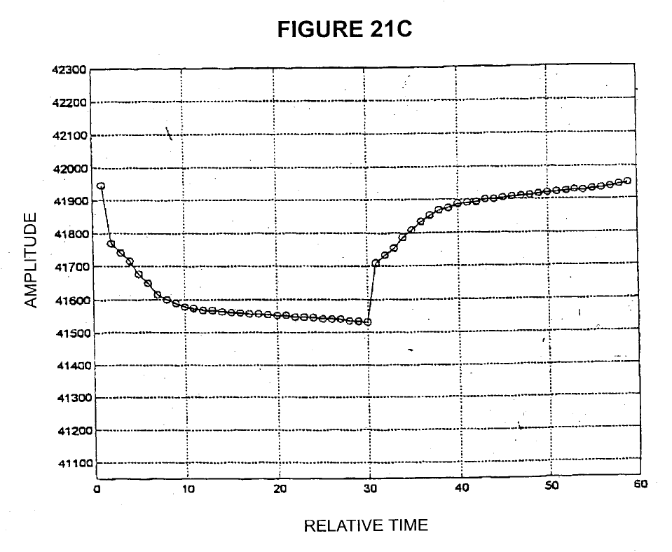

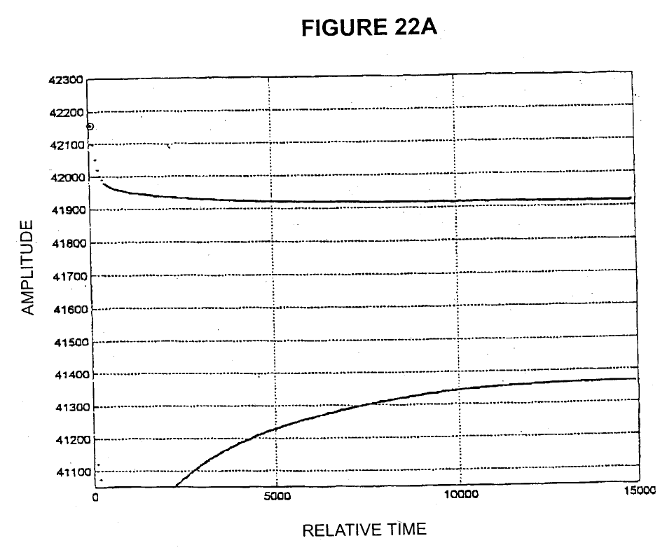

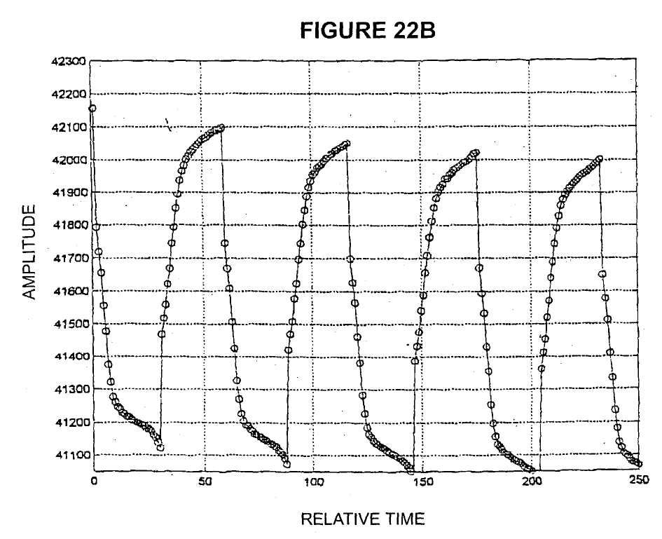

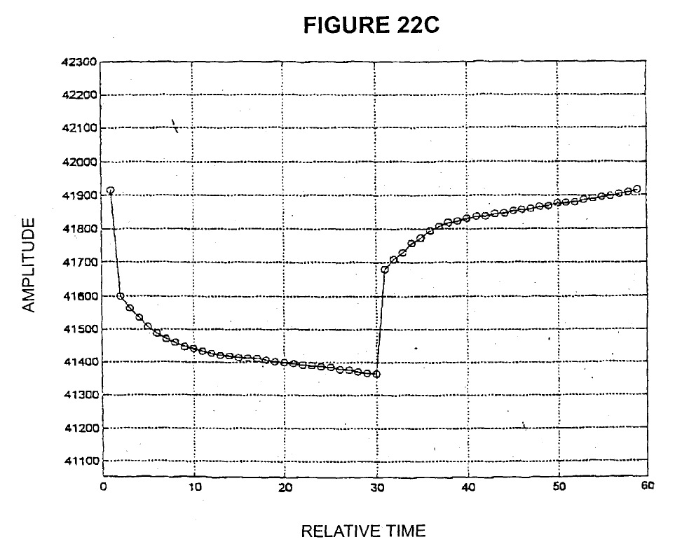

The cell was subjected to eight successive 2 hour, 400 milliampere discharges. By the end of the last discharge, the terminal voltage of the cell had fallen to 2.499 volts, indicating approaching ‘end of life’. FIGS. 15A-15C through FIGS. 22A-22C provide the details of the tests, each performed immediately prior to the upcoming discharge (and so, 24 hours after the preceding discharge event). FIGS. 15A-15C provide data 24 hours after the final discharge event. This ‘test followed by discharge’ protocol ensures that the data is representative of the cell's state of charge immediately preceding each discharge event, allowing quantitative, predictive relationships to be determined.

Referring to FIG. 15A, the very first two data points (a circle is used for the positive envelope points, a dot for the negative points) are coincident, and correspond to the open circuit voltage of the cell before the onset of the excitation. As soon as the excitation commences, the ‘loaded’ voltage of the cell (the lower extrema envelope curve in the plot) drops off precipitously, while the ‘recovery’ voltage of the cell (the upper extreme envelope curve in the plot) quickly assumes a constant value during the zero-current rest phase of each cycle. After a short while, the negative slope of the lower envelope reverses, as the ‘loaded’ cell voltage begins to recover. This effect is well known from standard discharge test profiles, but it is interesting that it appears so clearly under the present pulsed discharge/rest paradigm. What is unexpected is that the slope displayed by the upper side of the envelope is virtually constant for most of the duration of the test event, irrespective of the changes at the lower margin that represents the lower extrema envelope. The reason for this is that the upper curve represents the ‘recovered’ condition of the cell, in the absence of discharge current, whereas the shape bottom curve indicates the evolution of a new, stable dynamic equilibrium in response to the current during each discharge pulse. As will be explained below, it is the relationship between these two curves during each test, and especially their overall shape in comparison to previously established baseline data, that allows accurate determination of the cell's state of charge.

Because the LiSO₂ cell maintains a nearly constant open circuit terminal voltage over most of its operating life, OCV alone is not suitable as a direct indication of state of charge. However, when such cells are tested according to the disclosed method, the specific shape and amplitude of the resulting amplitude envelope signature curve reveals trends that are directly and monotonically correlated with state of charge. Both the upper and lower extreme envelops change as a function of state of charge.

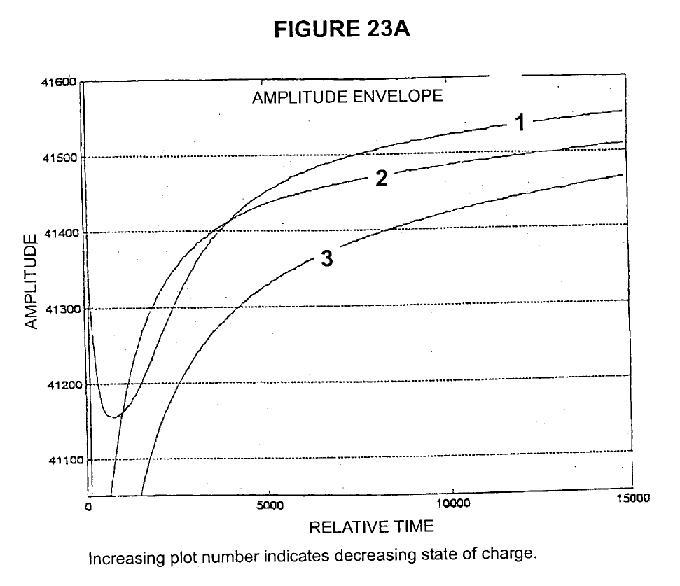

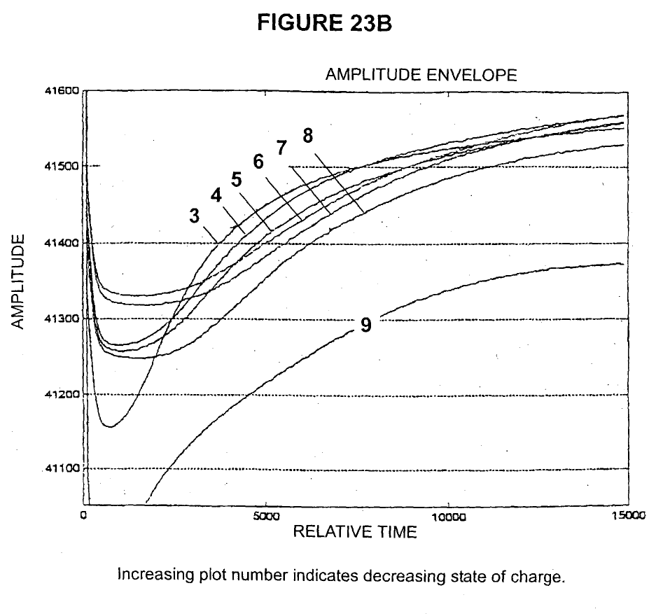

In the lower envelope, the characteristic of most importance is the position of the ascending portion of the curve following the inflection point (that is, the value along the ‘y’ time axis) as the slope becomes positive: as the cell's state of charge is reduced (i.e., progressively discharged), this ascending (and almost linear on the semi-log plot) portion moves toward the right, that is, occurs later in time following the onset of discharge excitation. This orderly progression continues until the cell nears the end of its life, whereupon the lower curve begins to move downward radically, indicating that the cell cannot sustain the discharge current. The lower extrema data from all the tests are compiled in FIGS. 23A and 23B. Note that the initial points of plots 1 and 2 fall well below the edge of the graph: this indicates substantial passivation, as expected since these data were obtained from the cell prior to any substantial discharging.

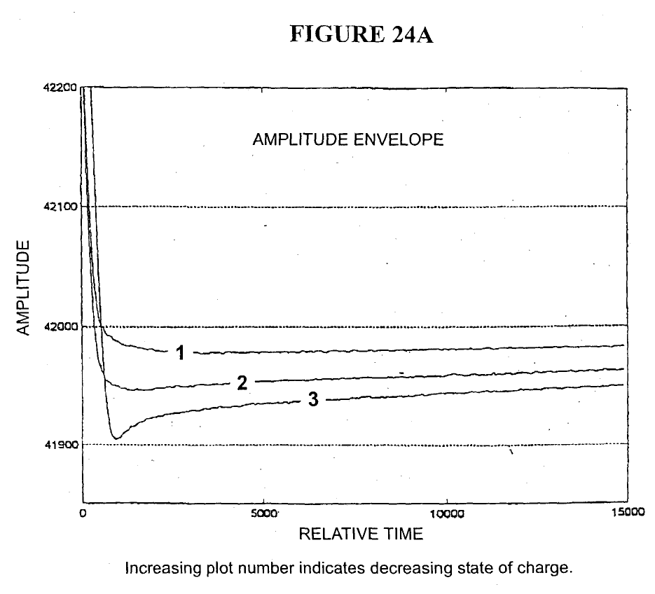

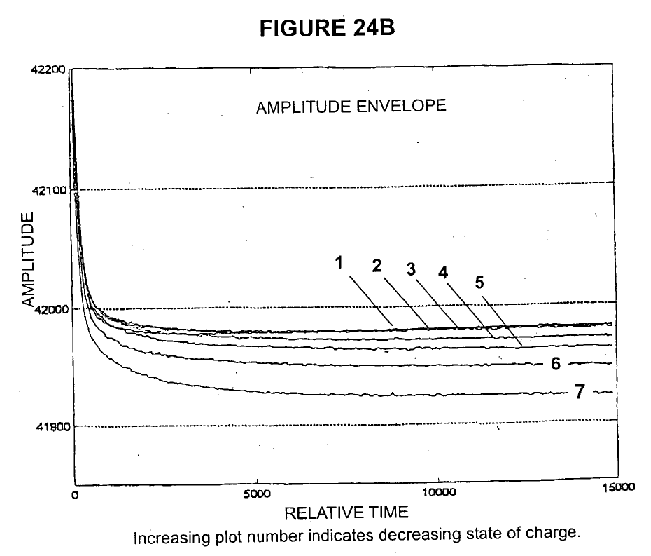

Throughout most of the cell's life, the upper extrema envelope is seen to hold a more stable value than the lower margin (depending of course on the amplitude of the discharge current). As the cell approaches complete discharge, the average DC value of the upper envelope begins to decrease. The magnitude of this decrement, as seen in FIGS. 24A and 24B, can then be used in conjunction with the lower extrema information as an effective indicator of state of charge toward the end of cell life.

Advantages Conferred by the Disclosed Method

State of charge can be accurately determined on the basis of a selected small number of raw data points taken from measurements on an unknown cell, and then compared to previously stored baseline values. This data reduction technique can be economically implemented using a sychronizable sampling means which takes data only at the pre-specified times (according to a sampling schedule stored in local microcomputer memory, or encoded as firmware within an ASIC or similar device) during the test sequence. The basic discharge/rest excitation method permits both the cell's ‘loaded terminal voltage’, and ‘recovery terminal voltage’ to be obtained during each cycle of a test event. From these data, both the upper and lower amplitude envelope extrema can be extracted, allowing high resolution state of charge estimation for cells at any charge condition. Defective or severely depleted cells will exhibit anomalous response data, and thereby they can be detected early on (within 100 microseconds) during the first discharge pulse. If a ‘defective’ or ‘discharged’ determination is made, testing may be terminated (or alternatively, the magnitude of the discharge pulses may be reduced) in a timely fashion, prior to catastrophic failure of the cell. When sufficiently high-speed sampling is employed (fast enough to capture the electrochemical events of interest in a specific application), specific cell failure mechanisms can be identified by the application of suitable analysis means.

Brand new cells, or partially depleted (used) cells that have become considerably passivated due to extended storage times, can be detected within a few tens of microseconds, and the excitation current can be increased accordingly for a few cycles to remove the passivation and then subsequently reduced, yielding more accurate test results and state of charge determination. The pulse/rest method permits relatively high current to be employed (as compared to the cell's nominal ‘C’ rate), permitting shorter test periods as compared with traditional DC discharge/open-circuit techniques. The present method employs an equivalent excitation frequency of 0.762 Hz. However, this may be modified to suit particular applications. The present method employs a 50% duty cycle excitation, however this ratio may be modified to suit particular applications. The present method employs an alternating sequence of constant amplitude discharge pulses and rest periods. However, the composition of the excitation sequence may be modified (e.g., varying the amplitude of successive pulses) to suit particular applications.

The method can be extended to apply to secondary (rechargeable) cells, by redefining the excitation to include charging pulses, interleaved appropriately with discharge and rest pulses. In this case, the amplitude envelope extrema will consist of four components: ‘discharging terminal voltage, ‘recovery-after-discharge terminal voltage’; ‘charging terminal voltage’; and ‘recovery-after-charge terminal voltage’. The former pair of components permits evaluation of the cell's ability to deliver energy, while the latter pair provides an estimate of the cell's energy (charge) acceptance capability, which is very important when this method is used within, for example, a charger, Uninterrupted Power Supply (UPS) or battery test/monitoring system.

The extended test method (charge/rest/discharge excitation) can be implemented directly within a rapid pulse-type charger, where the charging waveform is appropriately modulated to serve directly as the testing waveform. The measurement method may take the form of: software (embedded in a system which already provides the necessary hardware); a stand-alone instrument; an embedded controller or test subsystem; an integrated circuit or chip set. The method and apparatus may be used to implement diagnostic tools for commercial cell test and evaluation, or as a precision instrument intended for diverse analytic, electrochemical laboratory applications. The extended method wherein pulsing excitation and synchronous response sampling may be employed enhance speed and efficiency in ‘forming charge’ applications employed when a newly manufactured cell/battery is first charged. The present method may be generalized to operate with many cell/battery sizes and chemistries. The present method may be used to assist or control various commercially available battery systems, chargers, battery cyclers and battery evaluation/qualification devices.

Various signal processing and/or data analysis methods or algorithms, used in various combinations, may be applied to excitation-response data to analyze or otherwise generally characterize the underlying electrochemical processes within a cell or battery. Such methods may be parametric and/or nonparametric, may apply mathematical/numerical transformations of data (e.g. Fourier, Laplace, etc.), and may apply signal decomposition into its component parts, and/or other processing methods. These methods may be designed to extract information contained in the data, estimate/infer parameters of the system under test, for example by calculating basic parameters such as relative amplitude, bias, slopes, curvature, etc., or by fitting (as by numerical minimization of an error function) of measured or derived data to parameterized models. One example of the latter case is the estimation of time constants and initial conditions of “steady-state” transient response waveforms by fitting to parameterized model consisting of a sum of exponentials.

For such analysis, this technique is far superior to traditional Frequency Response Analysis, with its protracted measurement times, and the necessity for positing arbitrary equivalent electric circuits as a heuristic or predictive aid regarding the underlying electrochemical phenomena. The present method will allow assessment of the ‘rechargeability’, of an unknown cell (i.e., it won't try to charge a lithium primary, type, which is dangerous), and with suitable baseline data, allow immediate identification of various cell chemistries.

As described above, the methods described above may be embodied in the form of computer-based systems and apparatuses disposed to implement those methods. Existing systems having reprogrammable storage (e.g., non-volatile flash memory) may be updated to implement the invention. Furthermore, these methods may also be embodied in the form of computer program code, for example, whether stored in a storage medium such as floppy diskettes, CD-ROMs, hard drives, or any other computer-readable storage medium, or loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits disposed to implement the disclosed method.

While the inventive method and apparatus has been described with reference to several exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What we claim is:

1. A method for measuring a time-varying response of an electric or electrochemical system, which system may comprise any combination of electrical elements and electrochemical cells, comprising the steps of:
exciting the system with a time-varying current excitation signal provided by an excitation means;
acquiring digital samples with a sampling means synchronized with said excitation means, and operating in accordance with a pre-determined sampling schedule, which samples are taken of the voltage present across the system during the duration of the excitation,
performing any combination of the operations of:
displaying some or all of the acquired samples;
storing some or all of the acquired digital samples;
performing at least one analysis of the digital samples to evaluate at least one characteristic of said system.

2. The method of claim 1, comprising the additional step of:
acquiring digital samples with a sampling means synchronized with said excitation means, and operating in accordance with a pre-determined sampling schedule, which samples are taken of the voltage present across a sensing element disposed to exhibit a voltage proportional to an excitation current.

3. The method of claim 1, wherein the excitation signal is adjustable.

4. The method of claim 1, wherein at the step of exciting, the excitation comprises a time-varying current signal which exhibits exactly one abrupt discontinuity, which discontinuity may be either:
an abrupt step-wise change in the amplitude of the excitation; or
an abrupt step-wise change in the first time derivative of the amplitude of the excitation.

5. The method of claim 1, wherein the time-varying current excitation signal exhibits a plurality of abrupt discontinuities and comprises one or more waveforms, which waveform may be any of:
a rectilinear waveform, exhibiting a leading edge that constitutes an abrupt amplitude transition, followed by a substantially constant-amplitude portion, followed by another abrupt amplitude transition representing a trailing edge;
a ramping waveform comprising, in either order, an abrupt amplitude step representing an abrupt amplitude and a portion whose amplitude varies with time in a linear fashion, thus exhibiting a constant, but non-zero, first derivative with respect to time;
a triangle waveform comprising two distinct adjacent ramping segments each exhibiting a separate non-zero slope and whose adjacent ends are coincident at a point whereat the value of the slope of the waveform exhibits an abrupt transition;

6. The method of claim 1, wherein at the step of exciting, the excitation comprises a plurality of bipolar square waves, each comprising two part-cycles that have substantially identical duration, which part cycles have amplitudes that are substantially equal in magnitude but of opposite polarity.

7. The method of claim 1, wherein, over the course of a test event, the time average of the excitation current is non-zero so that either:
the DUT is excited with a net positive current representing charging; or
the DUT is excited with a net negative current representing discharging.

8. The method of claim 1 wherein at the step of exciting, the excitation comprises a consecutive series of identical 50% duty cycle rectangular waveforms, each of which waveforms exhibits one of the following sets of characteristics:
a: the waveform comprises one half-cycle representing a positive current pulse of a predetermined amplitude while the other of the half-cycle comprises a zero current rest period exhibiting the same duration as positive half cycle, which half-cycles can be arranged in either order;
b: the waveform comprises one half-cycle representing a negative current pulse of predetermined amplitude while the other of the half-cycle comprises a zero current rest period exhibiting the same duration as positive half cycle, which half-cycles can be arranged in either order;
c: the waveform comprises one half-cycle representing a positive current pulse of a first predetermined amplitude and another half-cycle representing a negative current pulse of a second predetermined amplitude exhibiting the same duration as the positive half cycle, which half-cycles can be arranged in either order, and which first and second predetermined may have either the same or different maximum amplitudes.

9. The method of claim 1, wherein at the step of exciting, the excitation comprises a plurality of rectangular current waveform cycles, at least one of which cycles may differ from any of the others with respect to at least one parameter, which parameters include:
amplitude value of either or both part cycles, which amplitude value may be positive, negative or zero;
cycle duration;
duty cycle ratio.

10. The method of claim 1, wherein the excitation current comprises a constant or slowly-varying component constituted to perform charging or discharging, coupled with a relatively rapidly varying component constituted according to claim 3, samples of which rapidly varying component may be synchronously acquired according to a pre-determined sampling schedule.

11. The method of claim 1, wherein the amplitude of at least a portion of the excitation applied during a test event is constituted to insure that no irreversible changes will be wrought on the DUT.

12. The method of claim t, wherein the amplitude of at least a portion of the excitation applied during a test event is constituted to insure that at least one irreversible change will be wrought on the DUT.

13. The method of claim 1, wherein the excitation means corresponds to a controlled current source that is disposed to provide either unipolar or bipolar current output, comprising one or a combination of:
a bipolar transistor operative within the feedback loop of an operational amplifier configured to control the current sourced by the transistor, in accordance with a separate controlling signal provided to the operational amplifier; or
a field effect transistor operative within the feedback loop of an operational amplifier configured to control the current sourced by the transistor, in accordance with a separate controlling signal provided to the operational amplifier; or
at least one operational amplifier configured to provide a controlled current output in accordance with a separate controlling signal provided to the at least one operational amplifier.

14. The method of claim 13, wherein the output of the controlled current source representing the excitation signal may be interrupted by means of an intervening, controllable switch means.

15. The method of claim 1, wherein the synchronous sampling means comprises an analog to digital converter equipped with a sampling clock control input connected to a synchronizing clock means.

16. The method of claim 1, wherein the synchronizing clock is provided by one of:
a controller means; or
a waveform generator means; or
an external clock signal source.

17. The method of claim 1, wherein the sampling schedule may be constituted as any one or combination of:
at least one set of time delay values have linearly increasing offsets with respect to a previously pre-determined point in time, which point may either represent the instant at which a test event commences, or represent the instant at which a waveform part-cycle commences;
at least one set of time delay values have exponentially increasing offsets with respect to a previously pre-determined point in time, which point may either represent the instant at which a test event commences, or represent the instant at which a waveform part-cycle commences;
at least one set of time delay values have parametrically increasing offsets with respect to a previously pre-determined point in time, which point may either represent the instant at which a test event commences or represent the instant at which a waveform part-cycle commences, and which set of values set need not correspond to a simple mathematical series.

18. The method of claim 1, wherein, irrespective of the amplitude of the excitation at the instant the test event commences, synchronous sampling commences concurrently with the beginning of the test event such that samples are acquired according to a predetermined set of time delay values.

19. The method of claim 1, wherein, irrespective of the amplitude of the excitation at time following the final abrupt transition in a test event, synchronous sampling may commence concurrently with said abrupt excitation transition and proceed according to a predetermined set of time delay values.

20. The method of claim 1, wherein synchronous sampling may commence concurrently with any abrupt excitation transition and proceed according to a predetermined set of time delay values.

21. The method of claim 1, wherein the sampling schedule is prestored.

22. The method of claim 1, wherein, during any portion of a test event, synchronous samples may be acquired from either the time-varying voltage response signal, or the excitation signal, or both.

23. The method of claim f, wherein the samples acquired by the synchronous samplers are provided as input to a controller means.

24. The method of claim 1; wherein the samples acquired by the synchronous sampler are stored in a memory means.

25. The method of claim 1, where at the step of evaluating, an analysis is performed on the sampled response data to determine the time constant of at least one component of the time-dependent voltage response emitted by the electrochemical system, and optionally thereafter, performing an additional analysis to determine the relative voltage amplitude coefficient associated with the process corresponding to said time constant.

26. The method of claim 1, where during the step of evaluating, at least one of the following analyses is performed:
a. determining the time constant of at least one component of the time-dependent voltage response emitted by the electrochemical system;
b. determining the relative amplitude coefficient associated with the process corresponding to a determined time constant;
c. analyzing the upper envelope-extrema comprising the set of maximum amplitude values attained by the response voltage during a plurality of successive response waveform cycles;
d. analyzing the lower envelope-extrema comprising the set of minimum amplitude values attained by the response voltage during a plurality of successive response waveform cycles;
e: performing a non-linear curve fitting analysis of at least one portion of at least one response cycle to extract information regarding the time constants and relative amplitudes of a set of exponential curves which can be added together to approximate the sampled data to an arbitrary degree of accuracy;
f: performing any integral transform method of analysis applied to the sampled data from one or more consecutive response cycles, whereby frequency domain data is developed from the sample time domain data;
g. computing the first time derivative for at least one pair of data points representing consecutive response samples;
h. computing the second time derivative for at least one triplet of data points representing consecutive response samples;
i. performing an analysis whereby the shape of at least one response waveform portion is characterized, thereby allowing pattern recognition and other correlation-based methods to be employed to extract information about the electrochemical system;
j. the sampled data is decimated to reduce the effective sampling rate, which decimated data may then be subject to any analysis.

27. The method of claim 1, further comprising, after the step of evaluating, the step of utilizing the information developed during the step of evaluating to characterize the electrochemical system by at least one of the following methods:
a. the extraction of information regarding the electrochemical system is achieved by comparing the results of at least one previous analysis to suitable benchmark data;
b. the extraction of information regarding the electrochemical system is achieved by performing a secondary analysis on information derived from the results of at least two previous analysis, the output of which secondary analysis is compared to suitable benchmark data;
c. the extraction of information from results of at least one previous analysis, allowing a characterization of the state of charge of the electrochemical system;
d. the extraction of information from results of at least one previous analysis, allowing a characterization of the state of health of the electrochemical system;
e. the extraction of information from results of at least one previous analysis, allowing a characterization of the electrochemical system as either severely depleted and/or defective.
f. the extraction of information from results of at least one previous analysis, allowing a characterization of at least one specific defect and/or failure mechanism in the electrochemical system;
g. the extraction of information from results of at least one previous analysis, allowing a characterization of the passivation state of the electrochemical system;
h. the extraction of information from results of at least one previous analysis, allowing a characterization of at least one underlying electrochemical process that occurs within the electrochemical system in response to the excitation;
i. the extraction of information from results of at least one previous analysis, allowing a characterization of at least one equivalent circuit model that describes the underlying electrochemical system;
j. the extraction of information from results of at least one previous analysis, allowing a determination of the rechargeability of the electrochemical system;
k: the extraction of information according to a fuzzy logic means applied either directly from the sampled data, or from the results of at least one previous analysis, which information may be used to determine the state of charge or state of health of the DUT;
l. the extraction of information according to a neural network means applied either directly from the sampled data, or from the results of at least one previous analysis results of at least one previous analysis, which information may be used to determine the state of charge or state of health of the DUT;
m. calculating the values of elements of an equivalent circuit model;
n. deriving by graphical means, the characteristics of at least one electrochemical process;

28. The method of claim 1, wherein at the step of acquiring, a parametric-by-pulse sampling schedule is employed whereby digital samples are acquired within each part-cycle, in a synchronous manner according to a pre-determined set of time delay values, which set need not correspond to a simple mathematical series, which delay values are synchronized with respect to the beginning of said part-cycle.

29. The method of claim 1, further comprising the step of:
performing a batch mode test processes, whereby a plurality of exciting/acquiring/evaluating test events are performed in consecutive order.

30. The method of claim 1, wherein the excitation amplitude provided during any part-cycle is either:
a: of a sufficiently small magnitude to ensure linear response within the cell/battery of cells; or
a: of a sufficiently small magnitude to ensure that the changes effected within the cell or battery of cells during the first part-cycle of an excitation waveform are fully reversed during the second part-cycle of said waveform; or
c. of a sufficiently large amplitude that the condition of the cell or battery of cells is changed, so that changes effected within the cell during the first part-cycle of an excitation waveform are not fully reversed during the second part-cycle of said waveform.

31. The method of claim 1, where in the number of sampled data points obtained during at least one half cycle corresponds exactly to an integral power of 2.

32. The method of claim 1, where the amplitude of each excitation pulse, corresponding to a part-cycle, is parametrically adjustable, and can, therefore, be changed to any value for any part-cycle.

33. An apparatus is provided that comprises:
a means of providing a time-varying current excitation to a system representing a DUT;
a means of acquiring synchronous samples of the voltage present across the system;
a means suitable for performing any combination of:
the display of some or all of the acquired samples;
the storage of some or all of the acquired digital samples;
at least one analysis of the digital samples to evaluate at least one characteristic of said system.

34. The apparatus of claim 33, further comprising a means of acquiring synchronous samples of the voltage present across a shunt element, which voltage is developed in response to the passage of an excitation current through said shunt element.

35. The apparatus of claim 33, wherein the connections between the apparatus and a DUT represent a Kelvin connection, comprising separate connections for: a current driver means; a current receiver means; and both inputs of a sensor means.

36. The apparatus of claim 33, wherein a controlled current source constitutes the excitation driver means, which current source is disposed to provide either unipolar or bipolar current output, comprising one or a combination of:
a bipolar transistor operative within the feedback loop of an operational amplifier configured to control the current sourced by the transistor, in accordance with a separate controlling signal provided to the operational amplifier; or
a field effect transistor operative within the feedback loop of an operational amplifier configured to control the current sourced by the transistor, in accordance with a separate controlling signal provided to the operational amplifier; or
at least one operational amplifier configured to provide a controlled current output in accordance with a separate controlling signal provided to the at least one operational amplifier.

37. The apparatus of claim 33, wherein a current receiver means is provided to receive a current signal from a DUT, which current receiver may comprise either:
a voltage controlled voltage source; or
an electrically conductive member disposed, by virtue of a connection to the local ground circuit of the test device, to maintain a potential of substantially zero volts when receiving an excitation current signal.

38. The apparatus of claim 33, wherein the excitation is adjusted to exhibit either:
a net positive current, to achieve a charging function for the DUT; or
a net negative current, to achieve a discharging function for the DUT

39. The apparatus of claim 33, where in the excitation comprises a composite signal exhibiting either a net positive or net negative aspect and which excitation includes portions characterized by abrupt transitions suitably disposed for eliciting a time-varying polarization response that may be synchronously sampled to yield samples that are analyzed to provide an evaluation of at least one characteristic of said system.

40. The apparatus of claim 33, wherein the excitation signal is modulated by feedback signal developed according to at least one evaluated characteristic, which modulation can take the form of:
a variation in any of the amplitude, duration or duty-cycle characteristics of the time varying waveform component of the excitation;
an alteration variation in a constant or slowly time-varying component of the excitation, which component may confer a net bias upon the excitation.

41. An apparatus, representing a preamplifier, is provided comprising:
at least one sense amplifier equipped with two differential input that are disposed to receive a differentially sensed input signal and produce an output that is a scaled replica of said differentially applied input signal, the potential of which output is referenced to common ground;
an inverting integrator means equipped with two differential inputs and providing an output that signal represents the inverse of the time integral of a differential input voltage provided across its two inputs, one of which is connected to a fixed potential and the other of which is connected to the output of said sense amplifier;
a inverting unity gain buffer amplifier, provide with an output, and an input that is connected to the output of said integrator;
a feedback connection between output of the inverting integrator and the non-inverting input of the sense amplifier and a feedback connection between the output of the buffer to the inverting input of the sense amplifier; which feedback connections jointly represent a offsetting signals which serve to keep the average value of the output of the sense amplifier at a potential of zero volts.

42. The apparatus of claim 41 wherein the buffer amplifier comprises an operational amplifier having a non-inverting input representing the input of the buffer, and an inverting input connected to a fixed potential of the same value as the fixed potential provided to the integrator means.

43. The apparatus of claim 41, wherein the fixed potential provided to the integrator means is a potential of zero volts, equivalent to a connection to common ground, and thereby the output of the integrator means appears referenced to common ground.

44. The apparatus of claim 41, where the time constant of the integrator is predetermined, and is substantially longer than the longest period of any time-varying response signal that may be presented to the inputs of the associated sense amplifier.

45. The method of claim 1, wherein at the step of exciting, the excitation corresponds to a periodic signal comprising at least one sine wave.

46. The apparatus of claim 33, wherein the excitation signal is modulated according to a control signal received from either a communications port or a local interface, which modulation can take the form of:
a variation in any of the amplitude, duration or duty-cycle characteristics of the time varying waveform component of the excitation;
an alteration variation in a constant or slowly time-varying component of the excitation, which component may confer a net bias upon the excitation.

47. The method of claim 1, wherein a sinusoidal excitation is employed, and synchronous sampling may commence at any time during the excitation, which point in time corresponds to a predetermined point in the current sine wave cycle and thereupon proceed according to a predetermined set of time delay values.
